(19) United States
(12) Patent Application Publication
(10) Pub. No.: US 2022/0416978 A1
(43) Pub. Date: Dec. 29, 2022

(54) APPARATUS AND METHODS FOR JOINT CHANNEL ESTIMATION IN UPLINK LINK OF A WIRELESS COMMUNICATION SYSTEM

(71) Applicant: Parsa Wireless Communications LLC, Stamford, CT (US)

(72) Inventor: Reza Kalbasi, San Diego, CA (US)

(73) Assignee: Parsa Wireless Communications LLC, Stamford, CT (US)

(21) Appl. No.: 17/850,005

(22) Filed: Jun. 27, 2022

Related U.S. Application Data
(60) Provisional application No. 63/215,831, filed on Jun. 28, 2021.

(51) Int. Cl. H04L 5/00; H04L 1/08

(52) U.S. Cl. CPC H04L 5/0053; H04L 1/08

(57) ABSTRACT

A method of data transmission includes detecting, by a base station, at least one of a plurality of aggregated time slots configured as a downlink (DL) time slot, determining whether to bundle plurality of demodulation reference signals (DMRSs), transmitting, to a user equipment (UE), a downlink control message (DCI) in the DL time slot, waiting, by the base station, for a time duration corresponding to a length of at least one symbol as a first indication gap, receiving, from the UE, the plurality of bundled DMRSs and performing channel estimation based on the bundled DMRSs.

### CROSS-REFERENCE TO RELATED APPLICATIONS

This application claims priority under 35 USC § 119(e) from U.S. Provisional Patent Application No. 63/215,831, filed on Jun. 28, 2021 (“the provisional application”); the content of the provisional patent application is incorporated herein by reference.

### BACKGROUND OF THE INVENTION

The present invention is directed to 5G, which is the 5th generation mobile network. It is a new global wireless standard after 1G, 2G, 3G, and 4G networks. 5G enables networks designed to connect machines, objects and devices.

The invention is more specifically directed to data transmission that includes detecting, by a base station, a plurality of aggregated time slots configured as a downlink (DL) time slot, determining whether to bundle a plurality of demodulation reference signals (DMRSs), transmitting, to a user equipment (UE), a downlink control message (DCI) in the DL time slot, waiting, by the base station, for a time duration corresponding to a length of at least one symbol as a first indication gap, receiving, from the UE, the plurality of bundled DMRSs and performing channel estimation based on the bundled DMRSs.

### SUMMARY OF THE INVENTION

In one embodiment, the invention provides a method of data transmission that includes detecting, by a base station, a plurality of aggregated time slots configured as a downlink (DL) time slot, determining whether to bundle a plurality of demodulation reference signals (DMRSs), transmitting, to a user equipment (UE), a downlink control message (DCI) in the DL time slot, waiting, by the base station, for a time duration corresponding to a length of at least one symbol as a first indication gap, receiving, from the UE, the plurality of bundled DMRSs and performing channel estimation based on the bundled DMRSs.

The step of determining may include measuring a wireless channel between the base station (BS) and the user equipment (UE), and based on the measurements, determining whether to bundle demodulation reference signals (DMRSs) or not. The plurality of bundled demodulation reference signals (DMRSs) preferably are in at least one physical uplink shared channel (PUSCH) repetition. The method may also include receiving a first set of bundled demodulation reference signals (DMRSs) in a first physical uplink shared channel (PUSCH) repetition in a first frequency band, waiting, by the base station, for a second time duration corresponding to a length of at least one symbol as a second indication gap, hopping, by the user equipment (UE), to a second frequency band; and receiving a second set of bundled DMRSs in a second PUSCH repetition in a second frequency band.

The second indication gap may be used by the user equipment (UE) to perform a Listen-Before-Talk (LBT) process. The second indication gap may be used by the user equipment (UE) to perform a Listen-Before-Talk (LBT) process. The plurality of bundled DMRSs may be are received in one or more aggregated time slots. The channel estimation may be performed using the bundled DMRSs in the one or more aggregated time slots. The detecting may include identifying a first available DL slot. The physical uplink shared channel (PUSCH) repetition may be a PUSCH type A repetition or a PUSCH type B repetition. For that matter, the at least one physical uplink shared channel (PUSCH) repetitions may be PUSCH type A repetitions or may be PUSCH type B repetitions.

In an embodiment, the invention provides a method of data transmission. The method includes detecting, by a user equipment (UE), at least one of a plurality of aggregated time slots configured as an uplink (UL) time slot, determining whether to bundle plurality of demodulation reference signals (DMRSs), transmitting, to a base station (BS), an uplink control information (UCI) message in the UL time slot, waiting, by the UE, for a time duration corresponding to a length of at least one symbol as a first indication gap and transmitting, to the BS, the plurality of bundled DMRSs. The step of determining include measuring a wireless channel between the base station (BS) and the user equipment (UE), and based on the measurements determine whether to bundle demodulation reference signals (DMRSs) or not. The plurality of bundled demodulation reference signals (DMRSs) preferably are in at least one physical uplink shared channel (PUSCH) repetition.

For that matter, the method further comprises transmitting a first set of bundled demodulation reference signals (DMRSs) in a first physical uplink shared channel (PUSCH) repetition in a first frequency band, waiting, by the user equipment (UE), for a second time duration corresponding to a length of at least one symbol as a second indication gap, hopping, by the UE, to a second frequency band; and transmitting a second set of bundled DMRSs in a second PUSCH. repetition in a second frequency band. The second indication gap preferably is used by the user equipment (UE) to perform a Listen-Before-Talk (LBT) process where the second indication gap preferably is used by the user equipment (UE) to perform a Listen-Before-Talk (LBT) process. The plurality of bundled demodulation reference signals (DMRSs) may be received in one or more aggregated time slots, where the detecting may comprise identifying a first available uplink (UL) time slot. For that matter, the physical uplink shared channel (PUSCH) repetition may be a PUSCH type A repetition, and may be a PUSCH type B repetition. The first and the second physical uplink shared channel (PUSCH) repetitions may be PUSCH type A repetitions or PUSCH type B repetitions.

In an embodiment, the invention provides a base station (BS) with a processor configured to detect at least one of a plurality of aggregated time slots configured as a downlink (DL) time slot and a transceiver in communication with the processor and configured to: transmit a first set of bundled DMRSs in a first physical uplink shared channel (PUSCH) repetition in a first frequency band and receive a second set of bundled demodulation reference signals (DMRSs) in a second PUSCH repetition in a second frequency band.

In another embodiment, the invention provides a user equipment (UE) with a processor configured to detect at least one of a plurality of aggregated time slots configured as downlink (UL); and a transceiver in communication with the processor and configured to: transmit a first set of bundled demodulation reference signals (DMRSs) in a first physical uplink shared channel (PUSCH) repetition in a first frequency band, transmit a second set of bundled DMRSs in a second PUSCH repetition in a second frequency band and wait for a time duration corresponding to a length of at least one symbol as a first indication gap; and a processor configured to perform channel estimation based on the bundled DMRSs.

### BRIEF DESCRIPTION OF THE DRAWINGS

FIG. 1 shows an example of a system of mobile communications according to some aspects of some of various exemplary embodiments of the present disclosure.

FIG. 2A and FIG. 2B show examples of radio protocol stacks for user plane and control plane, respectively, according to some aspects of some of various exemplary embodiments of the present disclosure.

FIG. 3A, FIG. 3B and FIG. 3C show example mappings between logical channels and transport channels in downlink, uplink and sidelink, respectively, according to some aspects of some of various exemplary embodiments of the present disclosure.

FIG. 4A, FIG. 4B and FIG. 4C show example mappings between transport channels and physical channels in downlink, uplink and sidelink, respectively, according to some aspects of some of various exemplary embodiments of the present disclosure.

FIG. 5A, FIG. 5B, FIG. 5C and FIG. 5D show examples of radio protocol stacks for NR sidelink communication according to some aspects of some of various exemplary embodiments of the present disclosure.

FIG. 6 shows example physical signals in downlink, uplink and sidelink according to some aspects of some of various exemplary embodiments of the present disclosure.

FIG. 7 shows examples of Radio Resource Control (RRC) states and transitioning between different RRC states according to some aspects of some of various exemplary embodiments of the present disclosure.

FIG. 8 shows example frame structure and physical resources according to some aspects of some of various exemplary embodiments of the present disclosure.

FIG. 9 shows example component carrier configurations in different carrier aggregation scenarios according to some aspects of some of various exemplary embodiments of the present disclosure.

FIG. 10 shows example bandwidth part configuration and switching according to some aspects of some of various exemplary embodiments of the present disclosure.

FIG. 11A shows example of downlink data and control signal transmission according to some aspects of some of various exemplary embodiments of the present disclosure.

FIG. 11B shows example of uplink data and control signal transmission according to some aspects of some of various exemplary embodiments of the present disclosure.

FIG. 12A shows an example of Demodulation Reference Signal (DMRS) bundling for Physical Uplink Shared Channel (PUSCH) repetition type A according to some aspects of some of various exemplary embodiments of the present disclosure.

FIG. 12B shows another example of Demodulation Reference Signal (DMRSs) bundling for Physical Uplink Shared Channel (PUSCH) repetition type B according to some aspects of some of various exemplary embodiments of the present disclosure.

FIG. 13A shows example of DMRS bundling for PUSCH repetition type A according to some aspects of some of various exemplary embodiments of the present disclosure.

FIG. 13B shows another example of DMRS bundling for PUSCH repetition type B according to some aspects of some of various exemplary embodiments of the present disclosure.

FIG. 14A shows example of DMRS bundling for PUSCH repetition type A with frequency hopping according to some aspects of some of various exemplary embodiments of the present disclosure.

FIG. 14B shows another example of DMRS bundling for PUSCH repetition type B with frequency hopping according to some aspects of some of various exemplary embodiments of the present disclosure.

FIG. 15A shows example of DMRS bundling for PUSCH repetition type A with frequency hopping according to some aspects of some of various exemplary embodiments of the present disclosure.

FIG. 15B shows another example of DMRS bundling for PUSCH repetition type B with frequency hopping according to some aspects of some of various exemplary embodiments of the present disclosure.

FIG. 16 shows example components of a user equipment for transmission and/or reception according to some aspects of some of various exemplary embodiments of the present disclosure.

FIG. 17 shows example components of a base station for transmission and/or reception according to some aspects of some of various exemplary embodiments of the present disclosure.

FIG. 18 is a flow diagram of illustrating a first example of a method of DMRS bundling determination according to some aspects of some of various exemplary embodiments of the present disclosure.

FIG. 19 is a flow diagram illustrating a second example of a method of DMRS bundling determination according to some aspects of some of various exemplary embodiments of the present disclosure.

FIG. 20 is a flow diagram illustrating a third example of a method of DMRS bundling determination according to some aspects of some of various exemplary embodiments of the present disclosure.

FIG. 21 is a flow diagram illustrating a fourth example of a method of DMRS bundling determination according to some aspects of some of various exemplary embodiments of the present disclosure.

### DETAILED DESCRIPTION

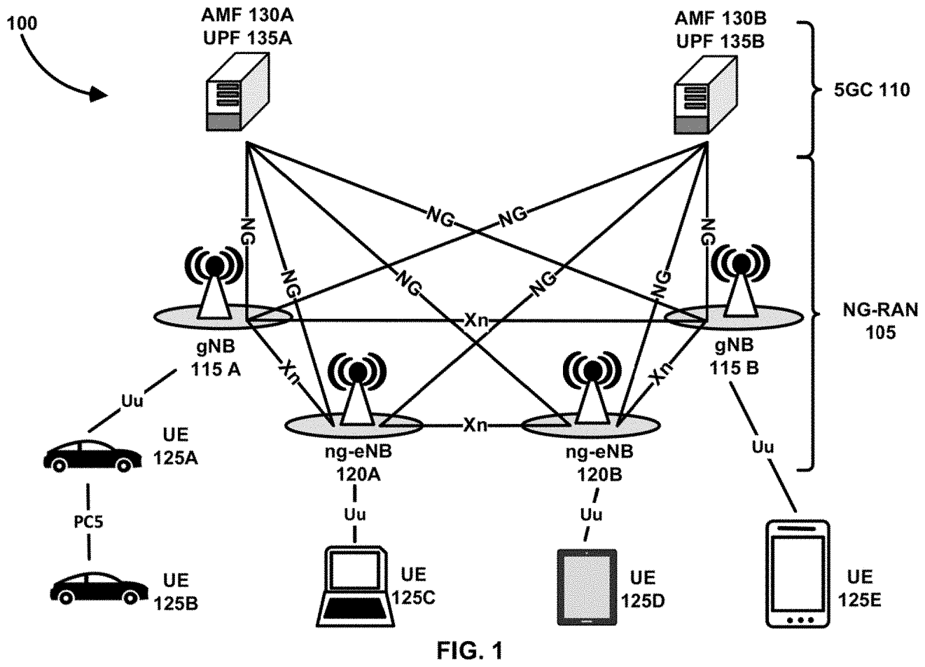

FIG. 1 shows an example of a system of mobile communications 100 according to some aspects of some of various exemplary embodiments of the present disclosure. The system of mobile communication 100 may be operated by a wireless communications system operator such as a Mobile Network Operator (MNO), a private network operator, a Multiple System Operator (MSO), an Internet of Things (IOT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial IOT (IIOT), etc.

The system of mobile communications 100 may enable various types of applications with different requirements in terms of latency, reliability, throughput, etc. Example supported applications include enhanced Mobile Broadband (eMBB), Ultra-Reliable Low-Latency Communications (URLLC), and massive Machine Type Communications (mMTC). eMBB may support stable connections with high peak data rates, as well as moderate rates for cell-edge users. URLLC may support application with strict requirements in terms of latency and reliability and moderate requirements in terms of data rate. Example mMTC application includes a network of a massive number of IoT devices, which are only sporadically active and send small data payloads.

The system of mobile communications 100 may include a Radio Access Network (RAN) portion and a core network portion. The example shown in FIG. 1 illustrates a Next Generation RAN (NG-RAN) 105 and a 5G Core Network (5GC) 110 as examples of the RAN and core network, respectively. Other examples of RAN and core network may be implemented without departing from the scope of this disclosure, Other examples of RAN include Evolved Universal Terrestrial Radio Access Network (EUTRAN), Universal Terrestrial Radio Access Network (UTRAN), etc. Other examples of core network include Evolved Packet Core (EPC), UMTS Core Network (UCN), etc. The RAN implements a Radio Access Technology (RAT) and resides between User Equipments (UEs) 125 and the core network. Examples of such RATs include New Radio (NR), Long Term Evolution (LTE) also known as Evolved Universal Terrestrial Radio Access (EUTRA), Universal Mobile Telecommunication System (UMTS), etc. The RAT of the example system of mobile communications 100 may be NR. The core network resides between the RAN and one or more external networks (e.g., data networks) and is responsible for functions such as mobility management, authentication, session management, setting up bearers and application of different Quality of Services (QoSs). The functional layer between the UE 125 and the RAN (e.g., the NG-RAN 105) may be referred to as Access Stratum (AS) and the functional layer between the UE 125 and the core network (e.g., the 5GC 110) may be referred to as Non-access Stratum (NAS).

The UEs 125 may include wireless transmission and reception means for communications with one or more nodes in the RAN, one or more relay nodes, or one or more other UEs, etc. Example of UEs include, but are not limited to, smartphones, tablets, laptops, computers, wireless transmission and/or reception units in a vehicle, V2X or Vehicle to Vehicle (V2V) devices, wireless sensors, IoT devices, IIOT devices, etc. Other names may be used for UEs such as a Mobile Station (MS), terminal equipment, terminal node, client device, mobile device, etc.

The RAN may include nodes (e.g., base stations) for communications with the UEs. For example, the NG-RAN 105 of the system of mobile communications 100 may comprise nodes for communications with the UEs 125. Different names for the RAN nodes may be used, for example depending on the RAT used for the RAN. A RAN node may be referred to as Node B (NB) in a RAN that uses the UMTS RAT. A RAN node may be referred to as an evolved Node B (eNB) in a RAN that uses LTE/EUTRA RAT. For the illustrative example of the system of mobile communications 100 in FIG. 1, the nodes of an NG-RAN 105 may be either a next generation Node B (gNB) 115 or a next generation evolved Node B (ng-eNB) 120. In this specification, the terms base station, RAN node, gNB and ng-eNB may be used interchangeably. The gNB 115 may provide NR user plane and control plane protocol terminations towards the UE 125. The ng-eNB 120 may provide E-UTRA user plane and control plane protocol terminations towards the UE 125. An interface between the gNB 115 and the UE 125 or between the ng-eNB 120 and the UE 125 may be referred to as a Uu interface. The Uu interface may be established with a user plane protocol stack and a control plane protocol stack. For a Uu interface, the direction from the base station (e.g., the gNB 115 or the ng-eNB 120) to the UE 125 may be referred to as downlink and the direction from the UE 125 to the base station (e.g., gNB 115 or ng-eNB 120) may be referred to as uplink.

The gNBs 115 and ng-eNBs 120 may be interconnected with each other by means of an Xn interface. The Xn interface may comprise an Xn User plane (Xn-U) interface and an Xn Control plane (Xn-C) interface. The transport network layer of the Xn-U interface may be built on Internet Protocol (IP) transport and CPRS Tunneling Protocol (GTP) may be used on top of User Datagram Protocol (UDP)/IP to carry the user plane protocol data units (PDUs). Xn-U may provide non-guaranteed delivery of user plane PDUs and may support data forwarding and flow control. The transport network layer of the Xn-C interface may be built on Stream Control Transport Protocol (SCTP) on top of IP. The application layer signaling protocol may be referred to as XnAP (Xn Application Protocol). The SCTP layer may provide the guaranteed delivery of application layer messages. In the transport IP layer, point-to-point transmission may be used to deliver the signaling PDUs. The Xn-C interface may support Xn interface management, UE mobility management, including context transfer and RAN paging, and dual connectivity.

The gNBs 115 and ng-eNBs 120 may also be connected to the 5GC 110 by means of the NG interfaces, more specifically to an Access and Mobility Management Function (AMF) 130 of the 5GC 110 by means of the NG-C interface and to a User Plane Function (UPF) 135 of the 5GC 110 by means of the NG-U interface. The transport network layer of the NG-U interface may be built on IP transport and GTP protocol may be used on top of UDP/IP to carry the user plane PDUs between the NG-RAN node (e.g., gNB 115 or ng-eNB 120) and the UPF 135. NG-U may provide non-guaranteed delivery of user plane PDUs between the NG-RAN node and the UPF. The transport network layer of the NG-C interface may be built on IP transport. For the reliable transport of signaling messages, SCTP may be added on top of IP. The application layer signaling protocol may be referred to as NGAP (NG Application Protocol). The SCTP layer may provide guaranteed delivery of application layer messages. In the transport, IP layer point-to-point transmission may be used to deliver the signaling PDUs. The NG-C interface may provide the following functions: NG interface management; UE context management; UE mobility management; transport of NAS messages; paging; PDU Session Management; configuration transfer; and warning message transmission.

The gNB 115 or the ng-eNB 120 may host one or more of the following functions: Radio Resource Management functions such as Radio Bearer Control, Radio Admission Control, Connection Mobility Control, Dynamic allocation of resources to UEs in both uplink and downlink (e.g., scheduling); IP and Ethernet header compression, encryption and integrity protection of data; Selection of an AMF at UE attachment when no routing to an AMF can be determined from the information provided by the UE; Routing of User Plane data towards UPF(s); Routing of Control Plane information towards AMP; Connection setup and release; Scheduling and transmission of paging messages; Scheduling and transmission of system broadcast information (e.g., originated from the AMF); Measurement and measurement reporting configuration for mobility and scheduling; Transport level packet marking in the uplink; Session Management; Support of Network Slicing; QoS Flow management and mapping to data radio bearers; Support of UEs in RRC Inactive state; Distribution function for NAS messages; Radio access network sharing; Dual Connectivity; Tight interworking between NR and E-UTRA; and Maintaining security and radio configuration for User Plane 5G system (5GS) Cellular IoT (CIoT) Optimization.

The AMF 130 may host one or more of the following functions: NAS signaling termination; NAS signaling security; AS Security control; Inter CN node signaling for mobility between 3GPP access networks; Idle mode UE Reachability (including control and execution of paging retransmission); Registration Area management; Support of intra-system and inter-system mobility; Access Authentication; Access Authorization including check of roaming rights; Mobility management control (subscription and policies); Support of Network Slicing; Session Management Function (SMF) selection; Selection of 5GS CIoT optimizations.

The UPF 135 may host one or more of the following functions: Anchor point for Intra-/Inter-RAT mobility (when applicable); External PDU session point of interconnect to Data Network; Packet routing & forwarding; Packet inspection and User plane part of Policy rule enforcement; Traffic usage reporting; Uplink classifier to support routing traffic flows to a data network; Branching point to support multi-homed PDU session; QoS handling for user plane, e.g. packet filtering, gating, UL/DL rate enforcement; Uplink Traffic verification (Service Data Flow (SDF) to QoS flow mapping); Downlink packet buffering and downlink data notification triggering.

As shown in FIG. 1, the NG-RAN 105 may support the PC5 interface between two UEs 125 (e.g., UE 125A and UE 125B). In the PC5 interface, the direction of communications between two UEs (e.g., from UE 125A to UE 125B or vice versa) may be referred to as sidelink. Sidelink transmission and reception over the PC5 interface may be supported when the UE 125 is inside NG-RAN 105 coverage, irrespective of which RRC state the UE is in, and when the UE 125 is outside NG-RAN 105 coverage. Support of V2X services via the PC5 interface may be provided by NR sidelink communication and/or V2X sidelink communication.

PC5-S signaling may be used for unicast link establishment with Direct Communication Request/Accept message. A UE may self-assign its source Layer-2 ID for the PC5 unicast link for example based on the V2X service type. During unicast link establishment procedure, the UE may send its source Layer-2 ID for the PC5 unicast link to the peer UE, e.g., the UE for which a destination ID has been received from the upper layers. A pair of source Layer-2 ID and destination Layer-2 ID may uniquely identify a unicast link. The receiving UE may verify that the said destination ID belongs to it and may accept the Unicast link establishment request from the source UE. During the PC5 unicast link establishment procedure, a PC5-RRC procedure on the Access Stratum may be invoked for the purpose of UE sidelink context establishment as well as for AS layer configurations, capability exchange etc. PC5-RRC signaling may enable exchanging UE capabilities and AS layer configurations such as Sidelink Radio Bearer configurations between pair of UEs for which a PC5 unicast link is established.

NR sidelink communication may support one of three types of transmission modes (e.g., Unicast transmission, Groupcast transmission, and Broadcast transmission) for a pair of a Source Layer-2 ID and a Destination Layer-2 ID in the AS. The Unicast transmission mode may be characterized by; Support of one PC5-RRC connection between peer UEs for the pair; Transmission and reception of control information and user traffic between peer UEs in sidelink; Support of sidelink HARQ feedback; Support of sidelink transmit power control; Support of RLC Acknowledged Mode (AM); and Detection of radio link failure for the PC5-RRC connection. The Groupcast transmission may be characterized by: Transmission and reception of user traffic among UEs belonging to a group in sidelink; and Support of sidelink HARQ feedback. The Broadcast transmission may be characterized by: Transmission and reception of user traffic among UEs in sidelink.

A Source Layer-2 ID, a Destination Layer-2 ID and a PC5 Link Identifier may be used for NR sidelink communication. The Source Layer-2 ID may be a link-layer identity that identifies a device or a group of devices that are recipients of sidelink communication frames. The Destination Layer-2 ID may be a link-layer identity that identifies a device that originates sidelink communication frames. In some examples, the Source Layer-2 ID and the Destination Layer-2 ID may be assigned by a management function in the Core Network. The Source Layer-2 ID may identify the sender of the data in NR sidelink communication. The Source Layer-2 ID may be 24 bits long and may be split in the MAC layer into two bit strings: One bit string may be the LSB part (8 bits) of Source Layer-2 ID and forwarded to physical layer of the sender. This may identify the source of the intended data in side link control information and may be used for filtering of packets at the physical layer of the receiver; and the Second bit string may be the MSB part (16 bits) of the Source Layer-2 ID and may be carried within the Medium Access Control (MAC) header. This may be used for filtering of packets at the MAC layer of the receiver. The Destination Layer-2 ID may identify the target of the data in NR sidelink communication. For NR sidelink communication, the Destination Layer-2 ID may be 24 bits long and may be split in the MAC layer into two bit strings: One bit string may be the LSB part (16 bits) of Destination Layer-2 ID and forwarded to physical layer of the sender. This may identify the target of the intended data in sidelink control information and may be used for filtering of packets at the physical layer of the receiver; and the Second bit string may be the MSB part (8 bits) of the Destination Layer-2 ID and may be carried within the MAC header. This may be used for filtering of packets at the MAC layer of the receiver. The PC5 Link Identifier may uniquely identify the PC5 unicast link in a UE for the lifetime of the PC5 unicast link. The PC5 Link Identifier may be used to indicate the PC5 unicast link whose sidelink Radio Link failure (RLF) declaration was made and PC5-RRC connection was released.

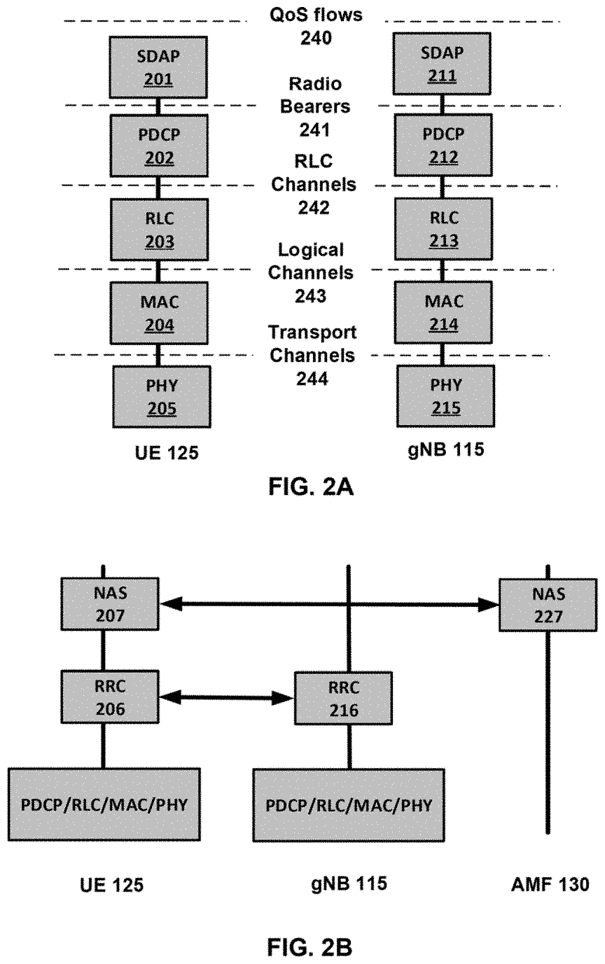

FIG. 2A and FIG. 2B show examples of radio protocol stacks for user plane and control plane, respectively, according to some aspects of some of various exemplary embodiments of the present disclosure. As shown in FIG. 2A, the protocol stack for the user plane of the Uu interface (between the UE 125 and the gNB 115) includes Service Data Adaptation Protocol (SDAP) 201 and SDAP 211, Packet Data Convergence Protocol (PDCP) 202 and PDCP 212, Radio Link Control (RLC) 203 and RLC 213, MAC 204 and MAC 214 sublayers of layer 2 and Physical (PHY) 205 and PHY 215 layer (layer 1 also referred to as L1).

The PHY 205 and PHY 215 offer transport channels 244 to the MAC 204 and MAC 214 sublayer. The MAC 204 and MAC 214 sublayer offer logical channels 243 to the RLC 203 and RLC 213 sublayer. The RLC 203 and RLC 213 sublayer offer RLC channels 242 to the PDCP 202 and PCP 212 sublayer. The PDCP 202 and PDCP 212 sublayer offer radio bearers 241 to the SDAP 201 and SDAP 211 sublayer. Radio bearers may be categorized into two groups: Data Radio Bearers (DRBs) for user plane data and Signaling Radio Bearers (SRBs) for control plane data. The SDAP 201 and SDAP 211 sublayer offers QoS flows 240 to 5GC.

The main services and functions of the MAC 204 or MAC 214 sublayer include: mapping between logical channels and transport channels; Multiplexing/demultiplexing of MAC Service Data Units (SDUs) belonging to one or different logical channels into/from Transport Blocks (TB) delivered to/from the physical layer on transport channels; Scheduling information reporting; Error correction through Hybrid Automatic Repeat Request (HARQ) (one HARQ entity per cell in case of carrier aggregation (CA)); Priority handling between UEs by means of dynamic scheduling; Priority handling between logical channels of one UE by means of Logical Channel Prioritization (LCP); Priority handling between overlapping resources of one UE; and Padding. A single MAC entity may support multiple numerologies, transmission timings and cells. Mapping restrictions in logical channel prioritization control which numerology(ies), cell(s), and transmission timing(s) a logical channel may use.

The HARQ functionality may ensure delivery between peer entities at Layer 1. A single HARQ process may support one TB when the physical layer is not configured for downlink/uplink spatial multiplexing, and when the physical layer is configured for downlink/uplink spatial multiplexing, a single HARQ process may support one or multiple TBs.

The RLC 203 or RLC 213 sublayer may support three transmission modes: Transparent Mode (TM); Unacknowledged Mode (UM); and Acknowledged Mode (AM). The RLC configuration may be per logical channel with no dependency on numerologies and/or transmission durations, and Automatic Repeat Request (ARQ) may operate on any of the numerologies and/or transmission durations the logical channel is configured with.

The main services and functions of the RLC 203 or RLC 213 sublayer depend on the transmission mode (e.g., TM, UM or AM) and may include: Transfer of upper layer PDUs; Sequence numbering independent of the one in PDCP (UM and AM); Error Correction through ARQ (AM only); Segmentation (AM and UM) and re-segmentation (AM only) of RLC SDUs; Reassembly of SDU (AM and UM); Duplicate Detection (AM only); RLC SDU discard (AM and UM); RLC re-establishment; and Protocol error detection (AM only).

The automatic repeat request within the RLC 203 or RLC 213 sublayer may have the following characteristics: ARQ retransmits RLC SDUs or RLC SDU segments based on RLC status reports; Polling for RLC status report may be used when needed by RLC; RLC receiver may also trigger RLC status report after detecting a missing RLC SDU or RLC SDU segment.

The main services and functions of the PDCP 202 or PDCP 212 sublayer may include: Transfer of data (user plane or control plane); Maintenance of PDCP Sequence Numbers (SNs); Header compression and decompression using the Robust Header Compression (ROHC) protocol; Header compression and decompression using EHC protocol; Ciphering and deciphering; Integrity protection and integrity verification; Timer based SDU discard; Routing for split bearers; Duplication; Reordering and in-order delivery; Out-of-order delivery; and Duplicate discarding.

The main services and functions of SDAP 201 or SDAP 211 include: Mapping between a QoS flow and a data radio bearer; and Marking QoS Flow ID (QFI) in both downlink and uplink packets. A single protocol entity of SDAP may be configured for each individual PDU session.

As shown in FIG. 2B, the protocol stack of the control plane of the Uu interface (between the UE 125 and the gNB 115) includes PHY layer (layer 1), and MAC, RLC; and PDCP sublayers of layer 2 as described above and in addition, the RRC 206 sublayer and RRC 216 sublayer. The main services and functions of the RRC 206 sublayer and the RRC 216 sublayer over the Uu interface include: Broadcast of System Information related to AS and NAS; Paging initiated by 5GC or NG-RAN; Establishment, maintenance and release of an RRC connection between the UE and NG-RAN (including Addition, modification and release of carrier aggregation; and Addition, modification and release of Dual Connectivity in NR or between E-UTRA and NR); Security functions including key management; Establishment, configuration, maintenance and release of SRBs and DRBs; Mobility functions (including Handover and context transfer; UE cell selection and reselection and control of cell selection and reselection; and Inter-RAT mobility); QoS management functions; UE measurement reporting and control of the reporting; Detection of and recovery from radio link failure; and NAS message transfer to/from NAS from/to UE. The NAS 207 and NAS 227 layer is a control protocol (terminated in AMF on the network side) that performs the functions such as authentication, mobility management, security control, etc.

The sidelink specific services and functions of the RRC sublayer over the Uu interface include: Configuration of sidelink resource allocation via system information or dedicated signaling; Reporting of UE sidelink information; Measurement configuration and reporting related to sidelink; and Reporting of UE assistance information for SL traffic pattern(s).

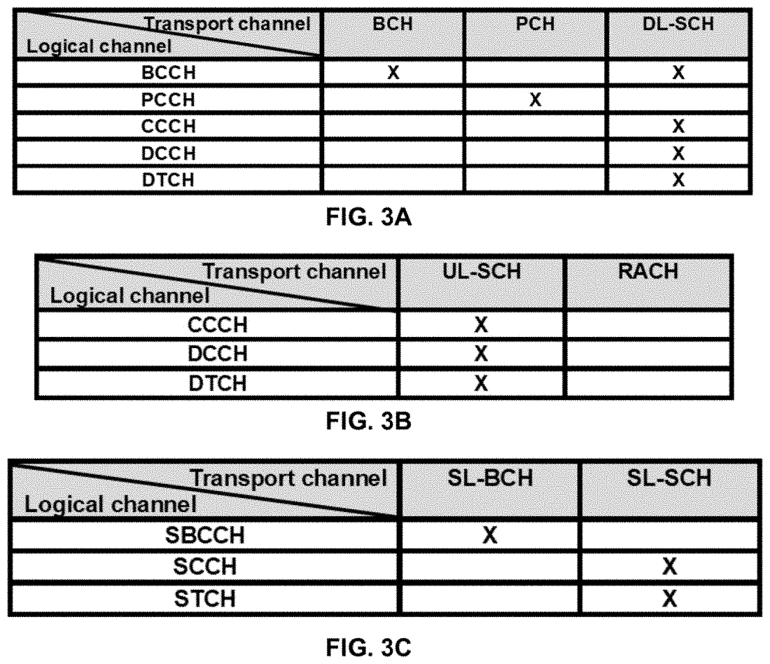

FIG. 3A, FIG. 3B and FIG. 3C show example mappings between logical channels and transport channels in downlink, uplink and sidelink, respectively, according to some aspects of some of various exemplary embodiments of the present disclosure. Different kinds of data transfer services may be offered by MAC. Each logical channel type may be defined by what type of information is transferred. Logical channels may be classified into two groups: Control Channels and Traffic Channels. Control channels may be used for the transfer of control plane information only. The Broadcast Control Channel (BCCH) is a downlink channel for broadcasting system control information. The Paging Control Channel (PCCH) is a downlink channel that carries paging messages. The Common Control Channel (CCCH) is channel for transmitting control information between UEs and network. This channel may be used for UEs having no RRC connection with the network. The Dedicated Control Channel (DCCH) is a point-to-point bi-directional channel that transmits dedicated control information between a UE and the network and may be used by UEs having an RRC connection. Traffic channels may be used for the transfer of user plane information only. The Dedicated Traffic Channel (DTCH) is a point-to-point channel, dedicated to one UE, for the transfer of user information. A DTCH may exist in both uplink and downlink. Sidelink Control Channel (SCCH) is a sidelink channel for transmitting control information (e.g., PC5-RRC and PC5-S messages) from one UE to other UE(s). Sidelink Traffic Channel (STCH) is a sidelink channel for transmitting user information from one UE to other UE(s). Sidelink Broadcast Control Channel (SBCCH) is a sidelink channel for broadcasting sidelink system information from one UE to other UE(s).

The downlink transport channel types include Broadcast Channel (BCH), Downlink Shared Channel (DL-SCH), and Paging Channel (PCH). The BCH may be characterized by: fixed, pre-defined transport format; and requirement to be broadcast in the entire coverage area of the cell, either as a single message or by beamforming different BCH instances. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; and the support for UE Discontinuous Reception (DRX) to enable UE power saving. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; support for UE discontinuous reception (DRX) to enable UI power saving. The PCH may be characterized by: support for UE discontinuous reception (DRX) to enable UE power saving (DRX cycle is indicated by the network to the UE); requirement to be broadcast in the entire coverage area of the cell, either as a single message or by beamforming different BCH instances; mapped to physical resources which can be used dynamically also for traffic/other control channels.

In downlink, the following connections between logical channels and transport channels may exist: BCCH may be mapped to BCH; BCCH may be mapped to DL-SCH; PCCH may be mapped to PCH; CCCH may be mapped to DL-SCH; DCCH may be mapped to DL-SCH; and DTCH may be mapped to DL-SCH.

The uplink transport channel types include Uplink Shared Channel (UL-SCH) and Random Access Channel(s) (RACH). The UL-SCH may be characterized by possibility to use beamforming; support for dynamic link adaptation by varying the transmit power and potentially modulation and coding; support for HARQ; support for both dynamic and semi-static resource allocation. The RACH may be characterized by limited control information; and collision risk.

In Uplink, the following connections between logical channels and transport channels may exist: CCCH may be mapped to UL-SCH; DCCH may be mapped to UL-SCH; and DTCH may be mapped to UL-SCH.

The sidelink transport channel types include: Sidelink broadcast channel (SL-BCH) and Sidelink shared channel (SL-SCH). The SL-BCH may be characterized by pre-defined transport format. The SL-SCH may be characterized by support for unicast transmission, groupcast transmission and broadcast transmission; support for both UE autonomous resource selection and scheduled resource allocation by NG-RAN; support for both dynamic and semi-static resource allocation when UE is allocated resources by the NG-RAN; support for HARQ; and support for dynamic link adaptation by varying the transmit power, modulation and coding.

In the sidelink, the following connections between logical channels and transport channels may exist: SCCH may be mapped to SL-SCH; STCH may be mapped to SL-SCH; and SBCCH may be mapped to SL-BCH.

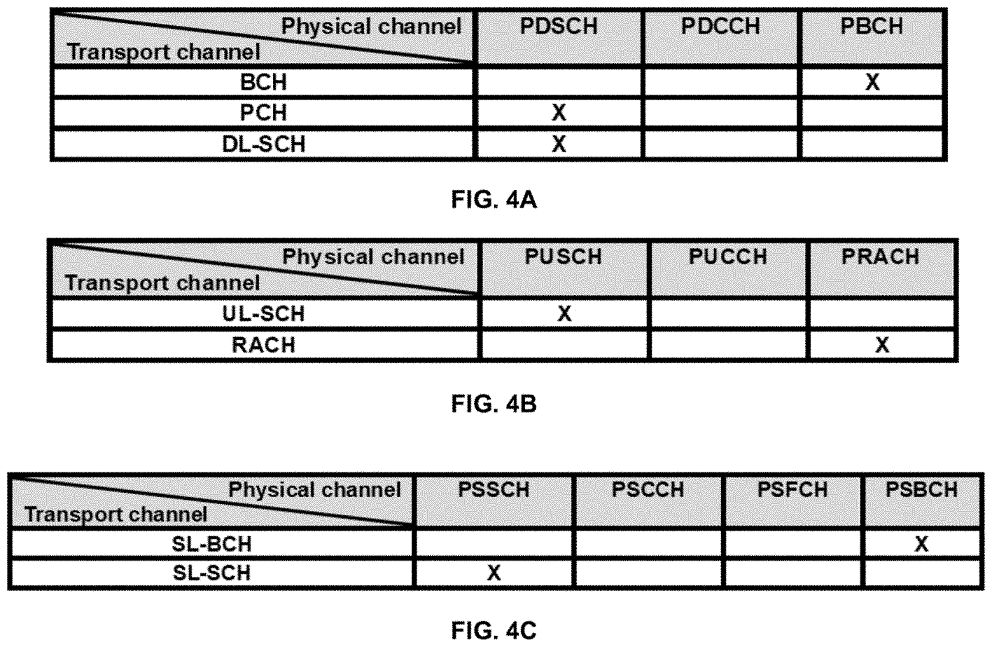

FIG. 4A, FIG. 4B and FIG. 4C show example mappings between transport channels and physical channels in downlink, uplink and sidelink, respectively, according to some aspects of some of various exemplary embodiments of the present disclosure. The physical channels in downlink include Physical Downlink Shared Channel (PDSCH), Physical Downlink Control Channel (PDCCH) and Physical Broadcast Channel (PBCH). The PCH and DL-SCH transport channels are mapped to the PDSCH. The BCH transport channel is mapped to the PBCH. A transport channel is not mapped to the PDCCH but Downlink Control Information (DCI) is transmitted via the PDCCH.

The physical channels in the uplink include Physical Uplink Shared Channel (PUSCH), Physical Uplink Control Channel (PUCCH) and Physical Random Access Channel (PRACH). The UL-SCH transport channel may be mapped to the PUSCH and the RACH transport channel may be mapped to the PRACH. A transport channel is not mapped to the PUCCH but Uplink Control Information (UCI) is transmitted via the PUCCH.

The physical channels in the sidelink include Physical Sidelink Shared Channel (PSSCH), Physical Sidelink Control Channel (PSCCH), Physical Sidelink Feedback Channel (PSFCH) and Physical Sidelink Broadcast Channel (PSBCH). The Physical Sidelink Control Channel (PSCCH) may indicate resource and other transmission parameters used by a UE for PSSCH. The Physical Sidelink Shared Channel (PSSCH) may transmit the TBs of data themselves, and control information for HARQ procedures and CSI feedback triggers, etc. At least 6 OFDM symbols within a slot may be used for PSSCH transmission. Physical Sidelink Feedback Channel (PSFCH) may carry the HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. The SL-SCH transport channel may be mapped to the PSSCH. The SL-BCH may be mapped to PSBCH. No transport channel is mapped to the PSFCH but Sidelink Feedback Control Information (SFCI) may be mapped to the PSFCH. No transport channel is mapped to PSCCH but Sidelink Control Information (SCI) may mapped to the PSCCH.

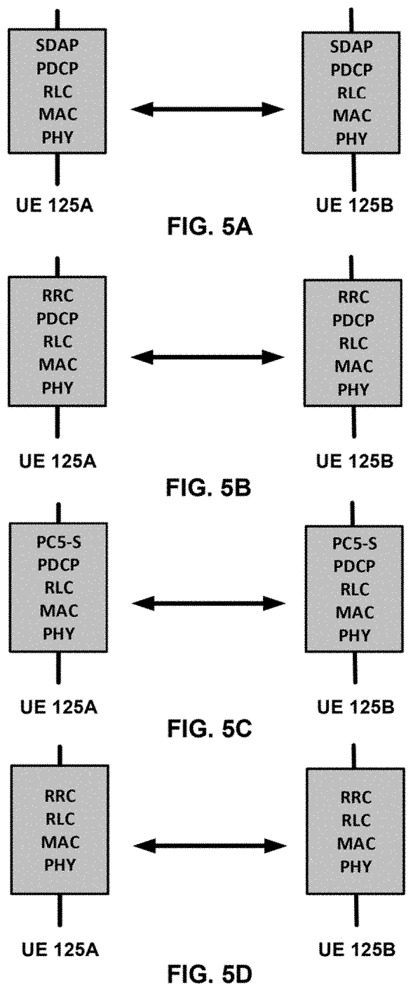

FIG. 5A, FIG. 5B, FIG. 5C and FIG. 5D show examples of radio protocol stacks for NR sidelink communication according to some aspects of some of various exemplary embodiments of the present disclosure. The AS protocol stack for user plane in the PC5 interface (i.e., for STCH) may consist of SDAP, PDCP, RLC and MAC sublayers, and the physical layer. The protocol stack of user plane is shown in FIG. 5A. The AS protocol stack for SBCCH in the PC5 interface may consist of RRC, RLC, MAC sublayers, and the physical layer as shown below in FIG. 5B. For support of PC5-S protocol, PC5-S is located on top of PDCP, RLC and MAC sublayers, and the physical layer in the control plane protocol stack for SCCH for PC5-S, as shown in FIG. 5C. The AS protocol stack for the control plane for SCCH for RRC in the PC5 interface consists of RRC, PDCP, RLC and MAC sublayers, and the physical layer. The protocol stack of control plane for SCCH for RRC is shown in FIG. 5D.

The Sidelink Radio Bearers (SLRBs) may be categorized into two groups: Sidelink Data Radio Bearers (SL DRB) for user plane data and Sidelink Signaling Radio Bearers (SL SRB) for control plane data. Separate SL SRBs using different SCCHs may be configured for PC5-RRC and PC5-S signaling, respectively.

The MAC sublayer may provide the following services and functions over the PC5 interface: Radio resource selection; Packet filtering; Priority handling between uplink and sidelink transmissions for a given UE; and Sidelink CSI reporting. With logical channel prioritization restrictions in MAC, only sidelink logical channels belonging to the same destination may be multiplexed into a MAC PDU for every unicast, groupcast and broadcast transmission which may be associated to the destination. For packet filtering, a SL-SCH MAC header including portions of both Source Layer-2 ID and a Destination Layer-2 ID may be added to a MAC MU. The Logical Channel Identifier (LCID) included within a MAC subheader may uniquely identify a logical channel within the scope of the Source Layer-2 ID and Destination Layer-2 ID combination.

The services and functions of the RLC sublayer may be supported for sidelink. Both RLC Unacknowledged Mode (UM) and Acknowledged Mode (AM) may be used in unicast transmission while only UM may be used in groupcast or broadcast transmission. For UM, only unidirectional transmission may be supported for groupcast and broadcast.

The services and functions of the PDCP sublayer for the Uu interface may be supported for sidelink with some restrictions: Out-of-order delivery may be supported only for unicast transmission; and Duplication may not be supported over the PC5 interface.

The SDAP sublayer may provide the following service and function over the PC5 interface: Mapping between a QoS flow and a sidelink data radio bearer. There may be one SDAP entity per destination for one of unicast, groupcast and broadcast which is associated to the destination.

The RRC sublayer may provide the following services and functions over the PC5 interface: Transfer of a PC5-RRC message between peer UEs; Maintenance and release of a PC5-RRC connection between two UEs; and Detection of sidelink radio link failure for a PC5-RRC connection based on indication from MAC or RLC. A PC5-RRC connection may be a logical connection between two UEs for a pair of Source and Destination Layer-2 IDs which may be considered to be established after a corresponding PC5 unicast link is established. There may be one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages may be used for a UE to transfer UE capability and sidelink configuration including SL-DRB configuration to the peer UE. Both peer UEs may exchange their own UE capability and sidelink configuration using separate bi-directional procedures in both sidelink directions.

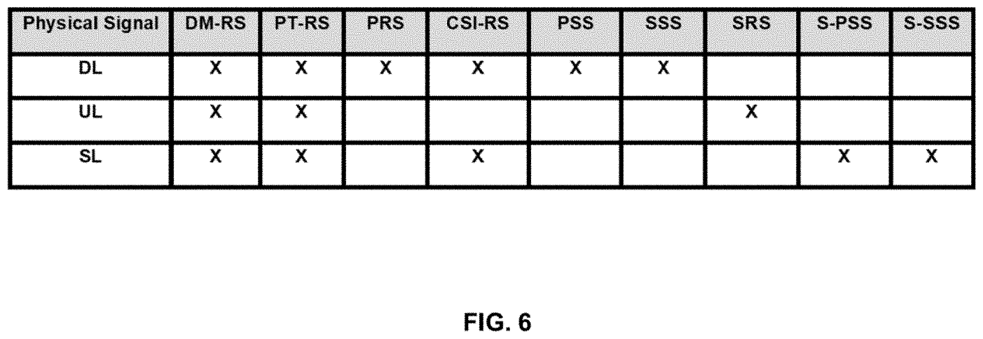

FIG. 6 shows example physical signals in downlink, uplink and sidelink according to some aspects of some of various exemplary embodiments of the present disclosure. The Demodulation Reference Signal (DM-RS) may be used in downlink, uplink and sidelink and may be used for channel estimation. DM-RS is a UE-specific reference signal and may be transmitted together with a physical channel in downlink, uplink or sidelink and may be used for channel estimation and coherent detection of the physical channel. The Phase Tracking Reference Signal (PT-RS) may be used in downlink, uplink and sidelink and may be used for tracking the phase and mitigating the performance loss due to phase noise. The PT-RS may be used mainly to estimate and minimize the effect of Common Phase Error (CPE) on system performance. Due to the phase noise properties, PT-RS signal may have a low density in the frequency domain and a high density in the time domain. PT-RS may occur in combination with DM-RS and when the network has configured PT-RS to be present. The Positioning Reference Signal (PRS) may be used in downlink for positioning using different positioning techniques. PRS may be used to measure the delays of the downlink transmissions by correlating the received signal from the base station with a local replica in the receiver. The Channel State Information Reference Signal (CSI-RS) may be used in downlink and sidelink. CSI-RS may be used for channel state estimation, Reference Signal Received Power (RSRP) measurement for mobility and beam management, time tracking for demodulation among other uses. CSI-RS may be configured UE-specifically but multiple users may share the same CSI-RS resource. The UE may determine CSI reports and transit them in the uplink to the base station using PUCCH or PUSCH. The CSI report may be carried in a sidelink MAC CE. The Primary Synchronization Signal (PSS) and the Secondary Synchronization Signal (SSS) may be used for radio fame synchronization. The PSS and SSS may be used for the cell search procedure during the initial attach or for mobility purposes. The Sounding Reference Signal (SRS) may be used in uplink for uplink channel estimation. Similar to CSI-RS, the SRS may serve as QCL reference for other physical channels such that they can be configured and transmitted quasi-collocated with SRS. The Sidelink PSS (S-PSS) and Sidelink SSS (S-SSS) may be used in sidelink for sidelink synchronization.

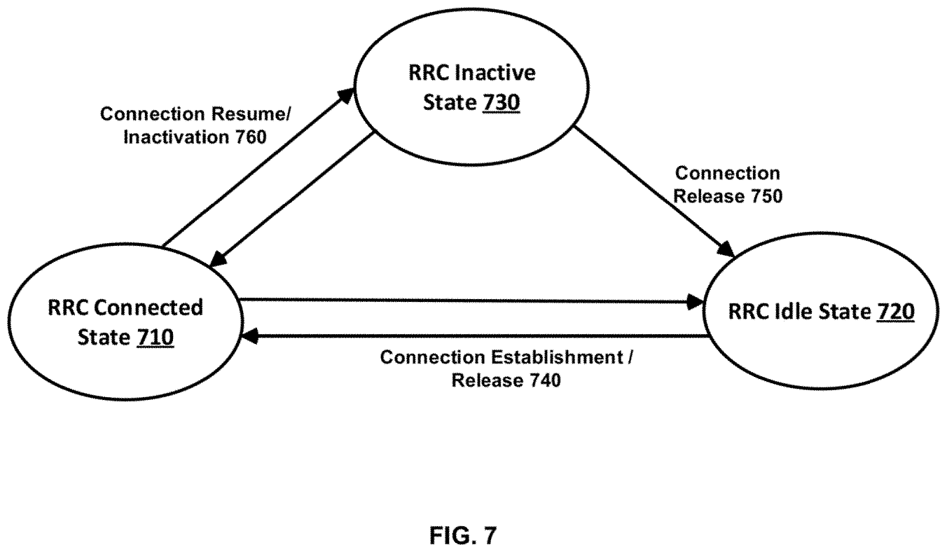

FIG. 7 shows examples of Radio Resource Control (RRC) states and transitioning between different RRC states according to some aspects of some of various exemplary embodiments of the present disclosure. A UE may be in one of three RRC states: RRC Connected State 710, RRC Idle State 720 and RRC Inactive state 730. After power up, the UE may be in RRC Idle state 720 and the UE may establish connection with the network using initial access and via an RRC connection establishment procedure to perform data transfer and/or to make/receive voice calls. Once RRC connection is established, the UE may be in RRC Connected State 710. The UE may transition from the RRC Idle state 720 to the RRC connected state 710 or from the RRC Connected State 710 to the RRC Idle state 720 using the RRC connection Establishment/Release procedures 740.

To reduce the signaling load and the latency resulting from frequent transitioning from the RRC Connected State 710 to the RRC Idle State 720 when the UE transmits frequent small data, the RRC Inactive State 730 may be used. In the RRC Inactive State 730, the AS context may be stored by both UE and gNB. This may result in faster state transition from the RRC Inactive State 730 to RRC Connected State 710. The UE may transition from the RRC Inactive State 730 to the RRC Connected State 710 or from the RRC Connected State 710 to the RRC Inactive State 730 using the RRC Connection Resume/Inactivation procedures 760. The UE may transition from the RRC inactive State 730 to RRC idle State 720 using an RRC Connection Release procedure 750.

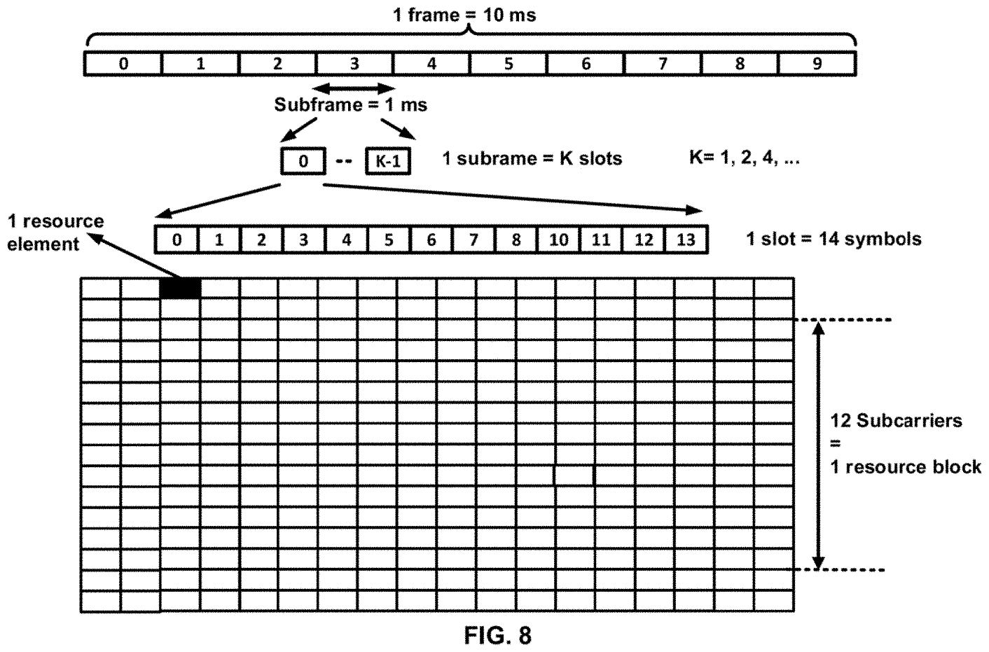

FIG. 8 shows example frame structure and physical resources according to some aspects of some of various exemplary embodiments of the present disclosure. The downlink or uplink or sidelink transmissions may be organized into frames with 10 ms duration, consisting off ten 1 ms subframes. Each subframe may consist of 1, 2, 4, slots, wherein the number of slots per subframe may depend of the subcarrier spacing of the carrier on which the transmission takes place. The slot duration may be 14 symbols with Normal Cyclic Prefix (CP) and 12 symbols with Extended CP and may scale in time as a function of the used sub-carrier spacing so that there is an integer number of slots in a subframe. FIG. 8 shows a resource grid in time and frequency domain. Each element of the resource grid, comprising one symbol in time and one subcarrier in frequency, is referred to as a Resource Element (RE). A Resource Block (RB) may be defined as 12 consecutive subcarriers in the frequency domain.

In some examples and with non-slot-based scheduling, the transmission of a packet may occur over a portion of a slot, for example during 2, 4 or 7 OFDM symbols which may also be referred to as mini-slots. The mini-slots may be used for low latency applications such as URLLC and operation in unlicensed bands. In some embodiments, the mini-slots may also be used for fast flexible scheduling of services (e.g., pre-emption of URLLC over eMBB).

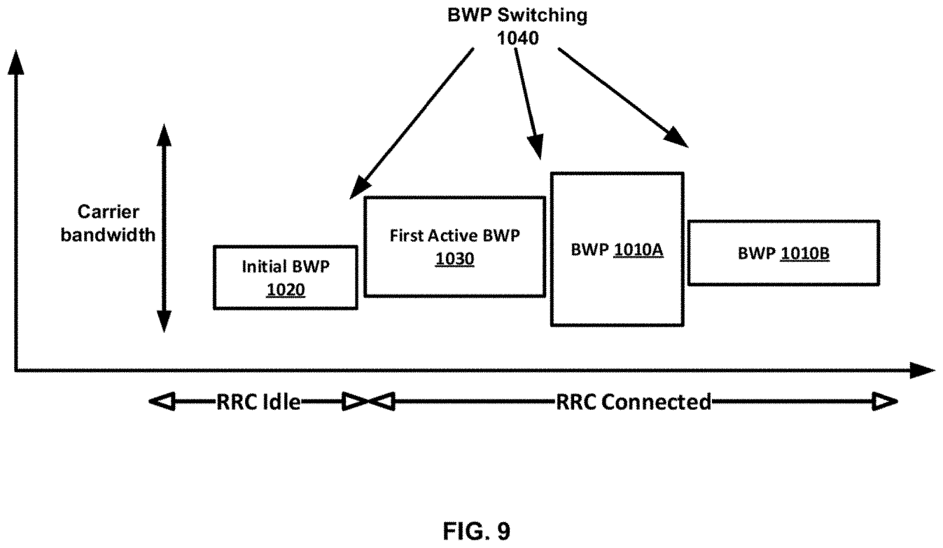

FIG. 9 shows example component carrier configurations in different carrier aggregation scenarios according to some aspects of some of various exemplary embodiments of the present disclosure. In Carrier Aggregation (CA), two or more Component Carriers (CCs) may be aggregated. A UE may simultaneously receive or transmit on one or multiple CCs depending on its capabilities. CA may be supported for both contiguous and non-contiguous CCs in the same band or on different bands as shown in FIG. 9. A gNB and the UE may communicate using a serving cell. A serving cell may be associated at least with one downlink CC (e.g., may be associated only with one downlink CC or may be associated with a downlink CC and an uplink CC). A serving cell may be a Primary Cell (PCell) or a Secondary cCell (SCell).

A UE may adjust the timing of its uplink transmissions using an uplink timing control procedure. A Timing Advance (TA) may be used to adjust the uplink frame timing relative to the downlink frame timing. The gNB may determine the desired Timing Advance setting and provides that to the UE. The UE may use the provided TA to determine its uplink transmit timing relative to the UE's observed downlink receive timing.

In the RRC Connected state, the gNB may be responsible for maintaining the timing advance to keep the L1 synchronized. Serving cells having uplink to which the same timing advance applies and using the same timing reference cell are grouped in a Timing Advance Group (TAG). A TAG may contain at least one serving cell with configured uplink. The mapping of a serving cell to a TAG may be configured by RRC. For the primary TAG, the UE may use the PCell as timing reference cell, except with shared spectrum channel access where an SCell may also be used as timing reference cell in certain cases. In a secondary TAG, the UE may use any of the activated SCells of this TAG as a timing reference cell and may not change it unless necessary.

Timing advance updates may be signaled by the gNB to the UE via MAC CE commands. Such commands may restart a TAG-specific timer which may indicate whether the L1 can be synchronized or not: when the timer is running, the L1 may be considered synchronized, otherwise, the L1 may be considered non-synchronized (in which case uplink transmission may only take place on PRACH).

A UE with single timing advance capability for CA may simultaneously receive and/or transmit on multiple CCs corresponding to multiple serving cells sharing the same timing advance (multiple serving cells grouped in one TAG). A UE with multiple timing advance capability for CA may simultaneously receive and/or transmit on multiple CCs corresponding to multiple serving cells with different timing advances (multiple serving cells grouped in multiple TAGs). The NG-RAN may ensure that each TAG contains at least one serving cell. A non-CA capable UE may receive on a single CC and may transmit on a single CC corresponding to one serving cell only (one serving cell in one TAG).

The multi-carrier nature of the physical layer in case of CA may be exposed to the MAC layer and one HARQ entity may be required per serving cell. When CA is configured, the UE may have one RRC connection with the network. At RRC connection establishment/re-establishment/handover, one serving cell (e.g., the PCell) may provide the NAS mobility information. Depending on UE capabilities, SCells may be configured to form together with the PCell a set of serving cells. The configured set of serving cells for a UE may consist of one PCell and one or more SCells. The reconfiguration, addition and removal of SCells may be performed by RRC.

In a dual connectivity scenario, a UE may be configured with a plurality of cells comprising a Master Cell Group (MCG) for communications with a master base station, a Secondary Cell Group (SCG) for communications with a secondary base station, and two MAC entities: one MAC entity and for the MCG for communications with the master base station and one MAC entity for the SCG for communications with the secondary base station.

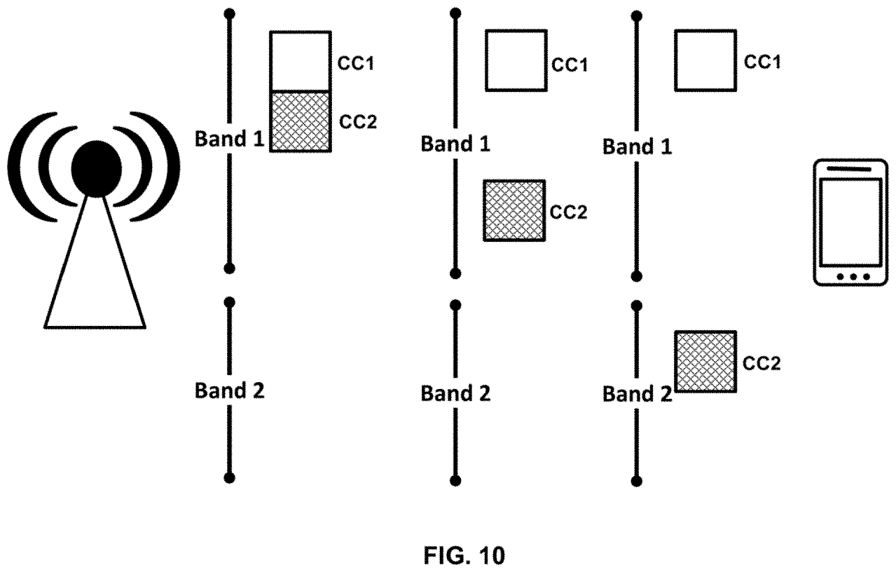

FIG. 10 shows example bandwidth part configuration and switching according to some aspects of some of various exemplary embodiments of the present disclosure. The UE may be configured with one or more Bandwidth Parts (BWPs) 1010 on a given component carrier. In some examples, one of the one or more bandwidth parts may be active at a time. The active bandwidth part may define the UE's operating bandwidth within the cell's operating bandwidth. For initial access, and until the configuration in a cell is received, initial bandwidth part 1020 determined from system information may be used. With Bandwidth Adaptation (BA), for example through BWP switching 1040, the receive and transmit bandwidth of a UE may not be as large as the bandwidth of the cell and may be adjusted. For example, the width may be ordered to change (e.g. to shrink during period of low activity to save power); the location may move in the frequency domain (e.g. to increase scheduling flexibility); and the subcarrier spacing may be ordered to change (e.g. to allow different services). The first active BWP 1020 may be the active BWP upon RRC (re-)configuration for a PCell or activation of an SCell.

For a downlink BWP or uplink BWP in a set of downlink BWPs or uplink BWPs, respectively, the UE may be provided the following configuration parameters; a Subcarrier Spacing (SCS); a cyclic prefix; a common RB and a number of contiguous RBs; an index in the set of downlink BWPs or uplink BWPs by respective BWP-Id; a set of BWP-common and a set of BWP-dedicated parameters. A BWP may be associated with an OFDM numerology according to the configured subcarrier spacing and cyclic prefix for the BWP. For a serving cell, a UE may be provided by a default downlink BWP among the configured downlink BWPs. If a UE is not provided a default downlink BWP, the default downlink BWP may be the initial downlink BWP.

A downlink BWP may be associated with a BWP inactivity timer. If the BWP inactivity timer associated with the active downlink BWP expires and if the default downlink BWP is configured, the UE may perform BWP switching to the default BWP. If the BWP inactivity timer associated with the active downlink BWP expires and if the default downlink BWP is not configured, the UE may perform BWP switching to the initial downlink BWP.

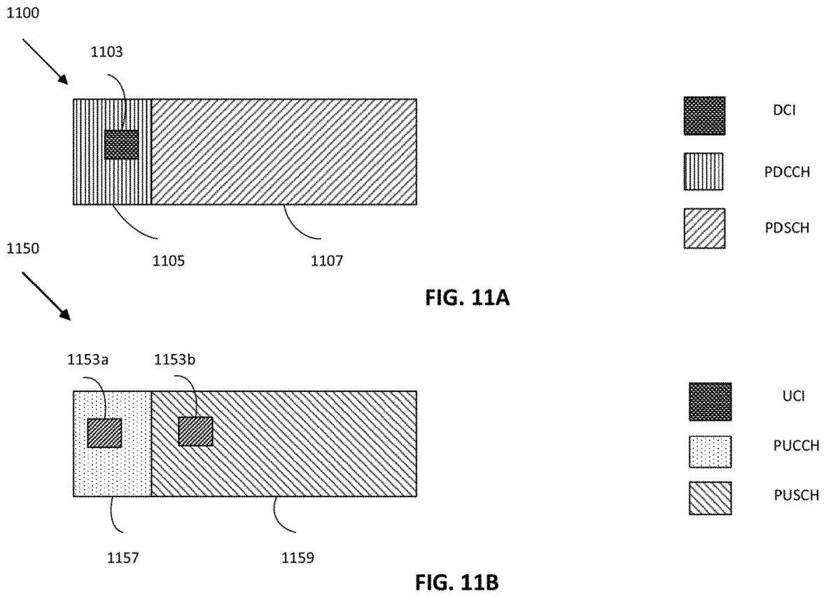

FIG. 11A is a diagram showing an example of a DL subframe 1100 according to some aspects of some of various exemplary embodiments of the present disclosure. The DL subframe 1100 may include a control portion 1105, and a data portion 1107. The control portion 1105 may exist in the initial portion of the DL subframe 1100. The control portion 1105 may include a Downlink Control Message (DCI) 1103. The DCI 1105 may include information required for decoding and scheduling a UE (e.g., UE 125). For instance, the DCI 1103 may include details such as number of resource blocks, resource allocation type, modulation scheme, transport block, redundancy version, coding rate etc. In some examples, the control portion 1105 may be a physical DL control channel (PDCCH), and the data portion 1107 may be a physical DL shared channel (PDSCH).

The data portion 1107 may be allocated to different users in a dynamic and opportunistic basis. The data portion 1107 may carry data from several Transport blocks (TBs) which may correspond to a MAC PDU. The TBs may be passed form the MAC layer to the PHY layer, and carried on the data portion 1107. To guard against propagation errors, Forward Error Correction (FEC) may be used on the data portion 1107 or control portion 1105. The control portion 1105 may be an aggregation of one or more several consecutive control channel elements (CCEs), where a control channel element may correspond to 9 resource elements groups.

FIG. 11B is a diagram showing an example of an UL subframe 1150 according to some aspects of some of various exemplary embodiments of the present disclosure. The UL subframe 1150 may include a control portion 1157, and a data portion 1159. The control portion 1157 may exist in the initial portion of the UL subframe 1150. The control portion 1157 or data portion may include an UL Control Message (UCI) 1153. The UCI 1153 may include feedback and scheduling information for a UE (e.g., UE 125). For instance, the UCIs 1153 may include details such as scheduling requests, HARQ ACK/NACK feedbacks, Channel Quality Indicator (CQI), etc. In some examples, the control portion 1157 may be a physical UL control channel (PUCCH), and the data portion 1157 may be a physical UL shared channel (PUSCH).

The data portion 1159 may contain user information data. In some example, the data portion carries both user data and control signaling The control information may be multiplexed with the user information data. To guard against propagation errors, Forward Error Correction (FEC) may be used on the data portion 1157 or control portion 1155.

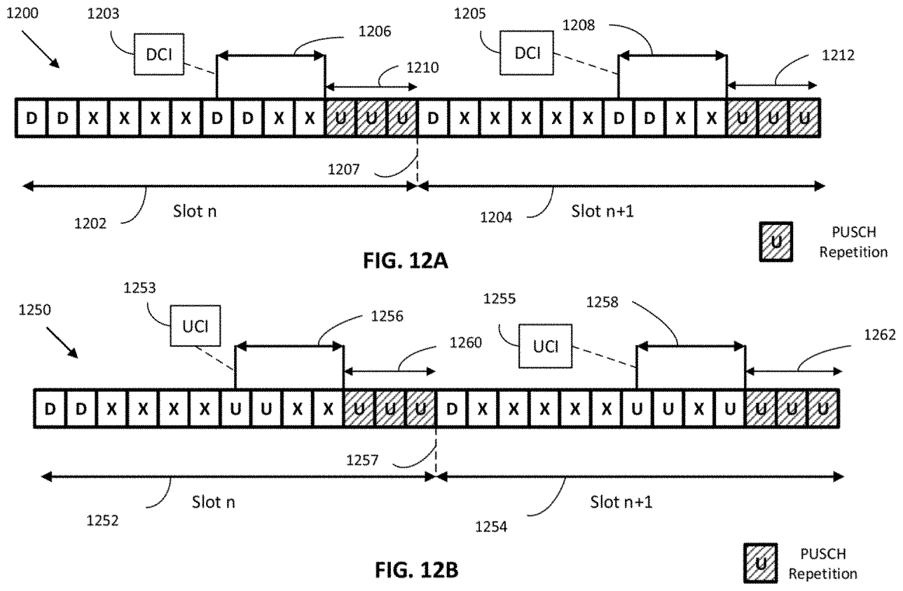

FIG. 12A is an example of a DMRS bundling scheme in UL link by a UE for PUSCH repetition type A according to some aspects of some of various exemplary embodiments of the present disclosure. As shown subframes 1200 includes two adjacent slots 1202, 1204. A BS (e.g., 120A, 120B) may configure a UE (e.g., UE 120A, 120B) frequency and time resources 1200 for transmission of data and control information. The symbols of the slots 1202, 1204 may be configured by the base station for UL (U), DL (D), or X (UL, DL). In this configuration PUSCH repetition type A 1210, 1212 may be configured by the BS for uplink transmission of data control signaling. In PUSCH repetitions type A slot boundary 1207 separates repetitions 1210 and 1212. The repetition length and starting symbol may be indicated to the UE from the BS by a DCI.

The BS may measure UL channel to decide if joint channel estimation across multiple PUSCHs can improve the UL UE performance. If the joint channel estimation can be done, the BS may detect at least one of plurality of aggregated time slots configured as DL, and may notify the UE via DCI 1203, 1208 to bundle DMRS across multiple PUSCH 1210, 1212. The BS may provide indication gaps 1206, 1208 to the UE to allow the UE sufficient time to consider DMRS bundling.

FIG. 12B is an example of a DMRS bundling scheme in UL link by a UE for PUSCH repetition type A according to some aspects of some of various exemplary embodiments of the present disclosure. As shown subframes 1250 includes two adjacent slots 1252, 1254. A BS (e.g., 120A, 120B) may configure a UE (e.g., UE 120A, 120B) frequency and time resources 1250 for transmission of data and control information. The symbols of the slots 1252, 1254 may be configured by the base station for UL (U), DL (D), or X (UL, DL). In this configuration PUSCH repetition type A 1260, 1262 may be configured by the BS for uplink transmission of data control signaling. In PUSCH repetitions type A slot boundary 1257 separates repetitions 1260 and 1262. The repetition length and starting symbol may be indicated to the UE from the BS by a DCI in an DL symbol.

The UE may measure DL channel, and from UL/DL channel reciprocity may decide if joint channel estimation across multiple PUSCHs can improve the UL UE performance. In some other example the UE may determine the UL channel quality from ACK/NACK feedback from the BS to determine UL channel quality. The UE may request to perform DMRS bundling via UCI 1253, 1255. The UE may detect at least one of plurality of aggregated time slots configured as UL, and may notify the BS via UCI 1253, 1258 to bundle DMRS across multiple PUSCH 1260, 1262. The UE may provide indication gaps 1256, 1258 to the UE to allow the UE sufficient time to consider DMRS bundling.

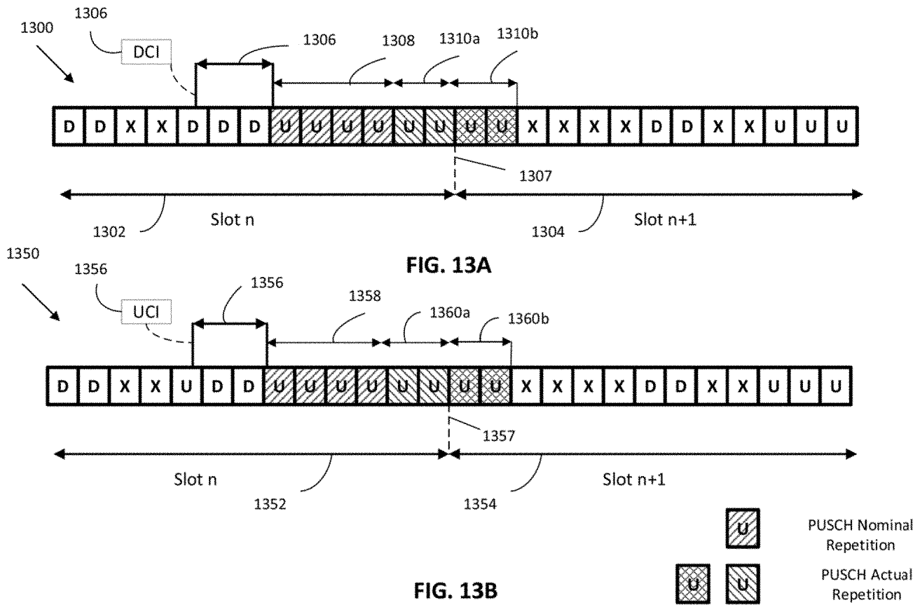

FIG. 13A is an example of a DMRS bundling scheme in UL link by a UE for PUSCH repetition type B according to some aspects of some of various exemplary embodiments of the present disclosure. As shown subframes 1300 includes two adjacent slots 1302, 1304. A BS (e.g., 120A, 120B) may configure a UE (e.g., UE 120A, 120B) frequency and time resources 1300 for transmission of data and control information. The symbols of the slots 1302, 1304 may be configured by the base station for UL (U), DL (D), or X (UL, DL). In this configuration PUSCH repetition type B 1308, 1310a-b may be configured by the BS for uplink transmission of data control signaling. In PUSCH repetitions type B slot boundary 1307 separates repetitions 1308 and 1310a-b. As shown, the PUSCH nominal repetition type B is split into two actual repetition 1310a, 1310b. The repetition length and starting symbol may be indicated to the UE from the BS by a DCI.

The BS may measure UL channel to decide if joint channel estimation across multiple PUSCHs can improve the UL UE performance. If the joint channel estimation can be done, the BS may detect at least one of plurality of aggregated time slots configured as DL, and may notify the UE via DCI 1203, 1208 to bundle DMRS across multiple PUSCH 1210, 1212. The BS may provide indication gap 1306 to the UE to allow the UE sufficient time to consider DMRS bundling.

FIG. 13B is an example of a DMRS bundling scheme in UL link by a UE for PUSCH repetition type B according to some aspects of some of various exemplary embodiments of the present disclosure. As shown subframes 1350 includes two adjacent slots 1352, 1354. A BS (e.g., 120A, 120B) may configure a UE (e.g., UE 120A, 120B) frequency and time resources 1350 for transmission of data and control information. The symbols of the slots 1352, 1354 may be configured by the base station for UL (U), DL (D), or X (UL, DL). In this configuration PUSCH repetition type B 1358, 1360a-b may be configured by the BS for uplink transmission of data control signaling. In PUSCH repetitions type B slot boundary 1357 separates repetitions 1360a-b. As shown, the PUSCH nominal repetition type B is split into two actual repetition 1360a, 1360b. The repetition length and starting symbol may be indicated to the UE from the BS by a DCI in an DL symbol.

The UE may measure DL channel, and from UL/DL channel reciprocity may decide if, joint channel estimation across multiple PUSCHs can improve the UL UE performance. In some other example the UE may determine the UL channel quality front ACK/NACK feedback from the BS to determine UL channel quality. The UE may request to perform DMRS bundling via UCI 1356. The UE may detect at least one of plurality of aggregated time slots configured as UL, and may notify the BS via UCI 1356 to bundle DMRS across multiple PUSCH 1358, 1360a-b. The UE may provide indication gaps 1356 to the UE to allow the UE sufficient time to consider DMRS bundling.

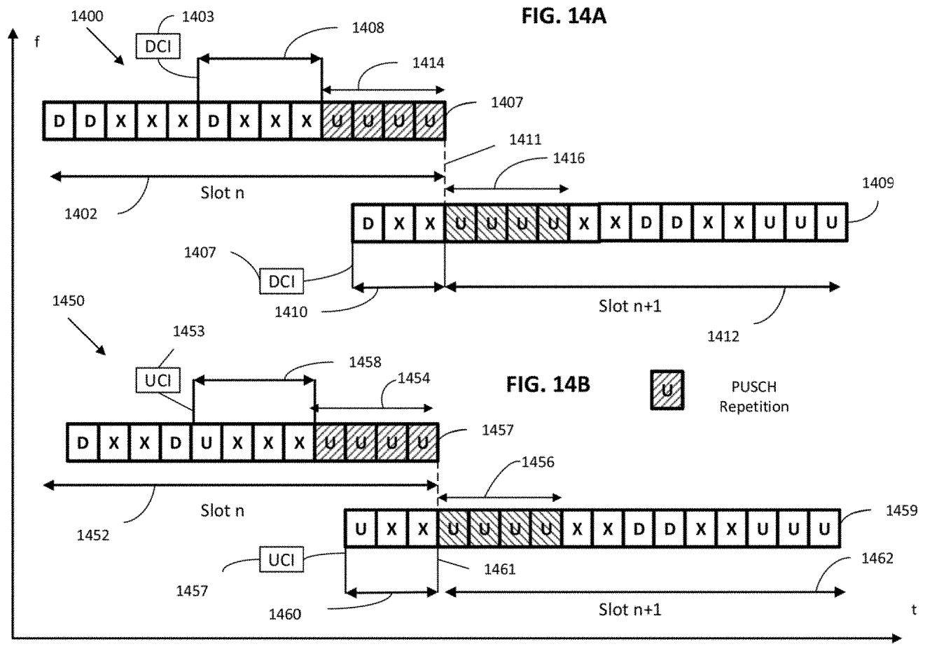

FIG. 14A is an example of a DMRS bundling scheme in UL link by a UE for PUSCH repetition type A with frequency hopping according to some aspects of some of various exemplary embodiments of the present disclosure. As shown subframes 1400 includes two adjacent slots 1402, 1412 in two different frequency hops 1407,1409 respectively. A BS (e.g., 120A, 120B) may configure a UE (e.g., UE 120A, 120B) frequency and time resources 1400 for transmission of data and control information. The symbols of the slots 1402, 1412 may be configured by the base station for UL (U), DL (D), or X (UL, DL). In this configuration PUSCH repetition type A 1414, 1416 may be configured by the BS for uplink transmission of data control signaling. In PUSCH repetition type B slot boundary 1407 separates repetitions 1414 and 1416. The repetition length and starting symbol may be indicated to the UE from the BS by a DCI.

The BS may measure UL channel to decide if joint channel estimation across multiple PUSCHs can improve the UL UE performance. If the joint channel estimation can be done, the BS may detect at least one of plurality of aggregated time slots configured as DL, and may notify the UE via DCI 1403, 1407 to bundle DMRS across multiple PUSCH 1414, 1416. The bundling of DMRS is done in each hop 1407, 1409 separately. The BS may provide indication gap 1408, 1410 to the UE to allow the UE sufficient time to consider DMRS bundling. The indication gap 1410 may also be used to measure channel in the frequency hop 1409, and to perform Listen before Talk (LBT) before switching to the frequency hop 1409.

FIG. 14B is an example of a DMRS bundling scheme in UL link by a UE for PUSCH repetition type A according to some aspects of some of various exemplary embodiments of the present disclosure. As shown subframes 1450 includes two adjacent slots 1452, 1454. A BS (e.g., 120A, 120B) may configure a UE (e.g., UE 120A, 120B) frequency and time resources 1340 for transmission of data and control information. The symbols of the slots 1452, 1458 may be configured by the base station for UL (U), (D), or X (UL, DL). In this configuration PUSCH repetition type A 1452, 1462 may be configured by the BS for uplink transmission of data control signaling. In PUSCH repetitions type A slot boundary 1411 separates repetitions 1414,1416. The repetition length and starting symbol may be indicated to the UE from the BS by a DCI in an DL symbol.

The UE may measure DL channel, and from UL/DL channel reciprocity may decide if joint channel estimation across multiple PUSCHs can improve the UL UE performance. In some other example the UE may determine the UL channel quality from ACK/NACK feedback from the BS to determine UL channel quality. The UE may request to perform DMRS bundling via UCI 1453,1457. The UE may detect at least one of plurality of aggregated time slots configured as UL, and may notify the BS via UCI 1454, 1456 to bundle DMRS across multiple PUSCH 1454, 1456. The DMRS bundling is done in each of the frequency hops 1457, 1459 separately. The UE may provide indication gaps 1458, 1459 to the UE to allow the UE sufficient time to consider DMRS bundling. The indication gap 1460 may also be used to measure channel in the frequency hop 1459, and to perform LBT before switching to the frequency hop 1459.

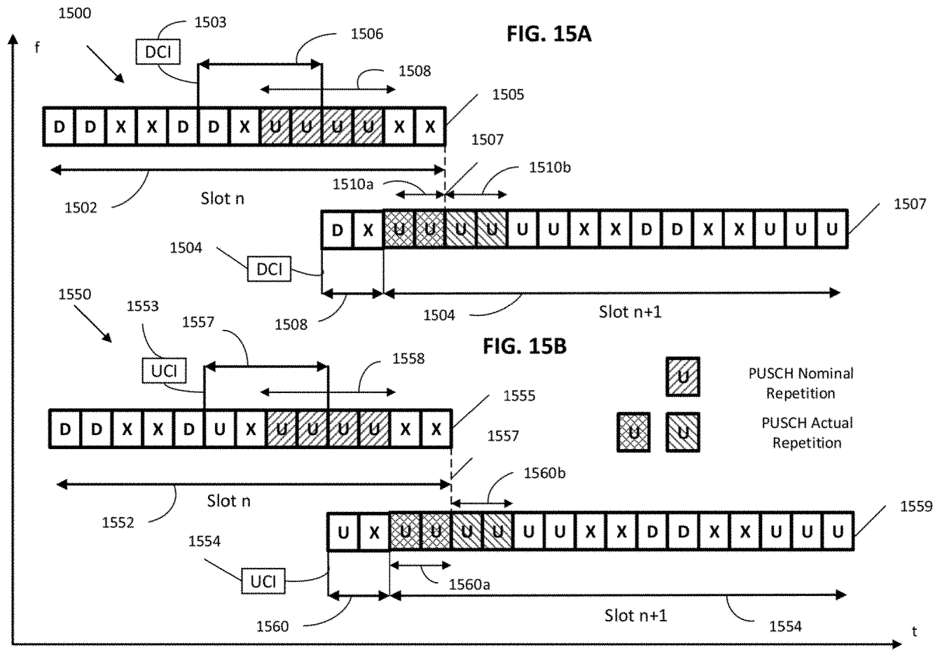

FIG. 15A is an example of a DMRS bundling scheme in UL link by a UE for PUSCH repetition type B with frequency hopping according to some aspects of some of various exemplary embodiments of the present disclosure. As shown subframes 1500 includes two adjacent slots 1502, 1504 in two different frequency hops 1505,1507 respectively. A BS (e.g., 120A, 120B) may configure a UE (e.g., UE 120A, 120B) frequency and time resources 1500 for transmission of data and control information. The symbols of the slots 1502, 1504 may be configured by the base station for UL (U), DL (D), or X (UL, DL). In this configuration PUSCH repetition type B 1508, 1510a-b may be configured by the BS for uplink transmission of data control signaling. In PUSCH repetitions type B slot boundary 1507 separates repetitions 1508 and 1510 (a-b). As shown, the nominal PUSCH repetition type B is split into actual repetitions 1510a-b. The repetition length and starting symbol may be indicated to the UE from the BS by a DCI.

The BS may measure UL channel to decide if joint channel estimation across multiple PUSCHs can improve the UL UE performance. If the joint channel estimation can be done, the BS may detect at least one of plurality of aggregated time slots configured as DL, and may notify the UE via DCI 1503, 1504 to bundle DMRS across multiple PUSCH 1508, 1510. The bundling of DMRS is done in each hop 1505, 1507 separately. The BS may provide indication gap 1506,1508 to the UE to allow the UE sufficient time to consider DMRS bundling. The indication gap 1508 may also be used to measure channel in the frequency hop 1507, and to perform Listen before Talk (LBT) before switching to the frequency hop 1507.

FIG. 15B is an example of a DMRS bundling scheme in UL link by a UE for PUSCH repetition type B according to some aspects of some of various exemplary embodiments of the present disclosure. As shown subframes 1550 includes two adjacent slots 1552, 1554 in frequency hops 1555, 1559 respectively. A BS (e.g., 120A, 12013) may configure a UE (e.g., UE 120A, 120B) frequency and time resources 1550 for transmission of data and control information. The symbols of the slots 1552, 1558 may be configured by the base station for UL (U), DL (D), or X (UL, DL). In this configuration PUSCH repetition type B 1558, 1560a-b may be configured by the BS for uplink transmission of data control signaling. As shown, the nominal repetition 1560 is split into actual repetition 1560a-b. The repetition length and starting symbol may be indicated to the UE from the BS by a DCI in an DL symbol.

The UE may measure channel, and from UL/DL channel reciprocity may decide if joint channel estimation across multiple PUSCHs can improve the UL UE performance. In some other example the UE may determine the UL channel quality from ACK/NACK feedback from the BS to determine UL channel quality. The UE may request to perform DMRS bundling via UCI 1553,1554. The UE may detect at least one of plurality of aggregated time slots configured as UL, and may notify the BS via UCI 1553, 1553 to bundle DMRS across multiple PUSCH 1558, 1560(a-b). The DMRS bundling is done in each of the frequency hops 1455, 1459 separately. The UE may provide indication gaps 1557, 1560 to the UE to allow the UE sufficient time to consider DMRS bundling. The indication gap 1560 may also be used to measure channel in the frequency hop 1559, and to perform LBT before switching to the frequency hop 1459.

Two types of Random Access (RA) procedure may be supported: 4-step PA type with MSG1 and 2-step RA type with MSGA. Both types of RA procedure may support Contention-Based Random Access (CBRA) and Contention-Free Random Access (CFRA) as shown in FIG. 11 and FIG. 12.

The UE may select the type of random access at initiation of the random access procedure based on network configuration. When CFRA resources are not configured, a RSRP threshold may be used by the UE to select between 2-step RA type and 4-step RA type. When CFRA resources for 4-step PA type are configured, UE may perform random access with 4-step RA type. When CFRA resources for 2-step RA type are configured, UE may perform random access with 2-step RA type.

The MSG1 of the 4-step RA type may consist of a preamble on PRACH. After MSG1 transmission, the UE may monitor for a response from the network within a configured window. For CFRA, dedicated preamble for MSG1 transmission may be assigned by the network and upon receiving Random Access Response (RAR) from the network, the UE may end the random access procedure as shown in FIG. 11. For CBRA, upon reception of the random access response, the UE may send MSG3 using the uplink grant scheduled in the random access response and may monitor contention resolution as shown in FIG. 11. If contention resolution is not successful after MSG3 (re)transmission(s), the UE may go back to MSG1 transmission.

The MSGA of the 2-step RA type may include a preamble on PRACH and a payload on PUSCH. After MSGA transmission, the UE may monitor for a response from the network within a configured window. For CFRA, dedicated preamble and PUSCH resource may be configured for MSGA transmission and upon receiving the network response, the UE may end the random access procedure as shown in FIG. 12. For CBRA, if contention resolution is successful upon receiving the network response, the UE may end the random access procedure as shown in FIG. 12; while if fallback indication is received in MSGB, the UE may perform MSG3 transmission using the uplink grant scheduled in the fallback indication and may monitor contention resolution. If contention resolution is not successful after MSG3 (re)transmission(s), the UE, may go back to MSGA transmission.

FIG. 13 shows example time and frequency structure of Synchronization Signal and Physical Broadcast Channel (PBCH) Block (SSB) according to some aspects of some of various exemplary embodiments of the present disclosure. The SS/PBCH Block (SSB) may consist of Primary and Secondary Synchronization Signals (PSS, SSS), each occupying 1 symbol and 127 subcarriers (e.g., subcarrier numbers 56 to 182 in FIG. 13), and PBCH spanning across 3 OFDM symbols and 240 subcarriers, but on one symbol leaving an unused part in the middle for SSS as show in FIG. 13. The possible time locations of SSBs within a half-frame may be determined by sub-carrier spacing and the periodicity of the half-frames, where SSBs are transmitted, may be configured by the network. During a half-frame, different SSBs may be transmitted in different spatial directions (i.e. using different beams, spanning the coverage area of a cell).

The PBCH may be used to carry Master information Block (MIB) used by a UE during cell search and initial access procedures. The UE may first decode PBCH/MIB to receive other system information. The MIB may provide the UE with parameters required to acquire System Information Block 1 (SIB1), more specifically, information required for monitoring of PDCCH for scheduling PDSCH that carries SIB1. In addition, MIB may indicate cell barred status information. The MIB and SIB1 may be collectively referred to as the minimum system information (SI) and SIB1 may be referred to as remaining minimum system information (RMSI). The other system information blocks (SIBs) (e.g., SIB2, SIB3, . . . , SIB10 and SIBpos) may be referred to as Other SI. The Other SI may be periodically broadcast on broadcast on-demand on DL-SCH (e.g., upon request from UEs in RRC Idle State, RRC Inactive State, or RRC connected State), or sent in a dedicated manner on DL-SCH to UEs in RRC Connected State (e.g., upon request, if configured by the network, from UEs in RRC Connected State or when the UE has an active BWP with no common search space configured).

FIG. 14 shows example SSB burst transmissions according to some aspects of some of various exemplary embodiments of the present disclosure. An SSB burst may include N SSBs and each SSB of the N SSBs may correspond to a beam. The SSB bursts may be transmitted according to a periodicity (e.g., SSB burst period). During a contention-based random access process, a UE may perform a random access resource selection process, wherein the UE first selects an SSB before selecting a RA preamble. The UE may select an SSB with an RSRP above a configured threshold value. In some embodiments, the UE may select any SSB if no SSB with RSRP above the configured threshold is available. A set of random access preambles may be associated with an SSB. After selecting an SSB, the UE may select a random access preamble from the set of random access preambles associated with the SSB and may transmit the selected random access preamble to start the random access process.

In some embodiments, a beam of the N beams may be associated with a CSI-RS resource. A UE may measure CSI-RS resources and may select a CSI-RS with RSRP above a configured threshold value. The UE may select a random access preamble corresponding to the selected CSI-RS and may transmit the selected random access process to start the random access process. If there is no random access preamble associated with the selected CSI-RS, the UE may select a random access preamble corresponding to an SSB which is Quasi-Collocated with the selected CSI-RS.

In some embodiments, based on the UE measurements of the CSI-RS resources and the UE CSI reporting, the base station may determine a Transmission Configuration Indication (TCI) state and may indicate the TCI state to the UE, wherein the UE may use the indicated TCI state for reception of downlink control information (e.g., via PDCCH) or data (e.g., via PDSCH). The UE may use the indicated TCI state for using the appropriate beam for reception of data or control information. The indication of the TCI states may be using RRC configuration or in combination of RRC signaling and dynamic signaling (e.g., via a MAC Control element (MAC CE) and/or based on a value of field in the downlink control information that schedules the downlink transmission). The TCI state may indicate a Quasi-Colocation (QCL) relationship between a downlink reference signal such as CSI-RS and the DM-RS associated with the downlink control or data channels (e.g., PDCCH or PDSCH, respectively).

In some embodiments, the UE may be configured with a list of up to M TCI-State configurations, using Physical Downlink Shared Channel (PDSCH) configuration parameters, to decode PDSCH according to a detected PDCCH with DCI intended for the UE and the given serving cell, where M may depends on the UE capability. Each TCI-State may contain parameters for configuring a QCL relationship between one or two downlink reference signals and the DM-RS ports of the PDSCH, the DM-RS port of PDCCH or the CSI-RS port(s) of a CSI-RS resource. The quasi co-location relationship may be configured by one or more RRC parameters. The quasi co-location types corresponding to each DL RS may take one of the following values: ‘QCL-TypeA’: {Doppler shift, Doppler spread, average delay, delay spread}; ‘QCL-TypeB’: {Doppler shift, Doppler spread}; ‘QCL-TypeC’: {Doppler shift, average delay}; ‘QCL-TypeD’: {Spatial Rx parameter}. The UE may receive an activation command (e.g., a MAC CE), used to map TCI states to the codepoints of a DCI field.

In some examples, as shown in FIG. 15, three procedures of beam management may be used with beam sweeping on TRP/BS and/or on the UE side: Procedure 1 (P1): TRP/BS beam sweeping and UE beam sweeping; Procedure 2 (P2): TRP/BS beam sweeping only; and Procedure 3 (P3): UE beam sweeping only. In some examples, to perform sweeping over multiple Tx beams, each Tx beam may be transmitted on an RS resource for beam management. In some examples, to perform sweeping over multiple Rx beams, a Tx beam may be transmitted repeatedly multiple times in the same RS resource set so that receive side may sweep its Rx beams in multiple transmission instants. For downlink beam management, the TRP/BS may have a set of N Tx beams and the UE may have a set of M Rx beams for beam sweeping in P1. Each of the N Tx beams may be transmitted M times from the TRP/BS side so that may be received using M multiple beams per Tx beam. For P2, N BF CSI-RS transmission instants may be required since the UE receives a set of N Tx beams with the same Rx beam. For P3, it may require M beamformed CSI-RS transmission instants with the same Tx beam for the UE to sweep M Rx beams. In some examples, for uplink beam management, the process may be the same except that the transmit side and receive side may be switched between TRP and UE.

In some examples, the UE and/or TRP/BS may perform beam measurement by measuring beam sweeping based RS, e.g., CSI-RS, for downlink and SRS for uplink. For downlink, a UE may measure the received power of a beamformed RS and may determine the beam quality based on the beam measurement. Based on the measurement, beam grouping may be performed by the UE. A UE may group downlink Tx beams into the same beam group, according to spatial channel properties (e.g., angle of arrival, spatial correlation, etc.) observed by the UE. In some examples, multiple TRP Tx beams may correspond to the same Rx beam at UE. In some examples, multiple Tx-Rx beam pairs may be considered as multiple-to-one beam grouping.

In some examples, a UE may report beam information including measurement quantities for N downlink Tx beams and information indicating these N beams, e.g., DL RS ID(s). The measurement quantities may be in the form of reference signal received power (RSRP). Depending on whether beam grouping is performed or not, the beam reporting format may be group-based reporting or non-group-based reporting.

In some examples, based on the group-based reporting, the N downlink Tx beams in a reporting instance may be received simultaneously by the UE by multiple receive panels. The subsequent DL transmission may be scheduled with up to N downlink Tx beams. In some examples, based on non-group-based reporting, a UE may report the N downlink beams with the N-best received power. The subsequent DL transmission may be performed with one Tx beam selected from the N beams. The TRP/BS may not know which beams may be simultaneously received by the UE.

In some examples, based on downlink Tx beams, measurement quantities and grouping information reported by UEs, the TRP may determine the beam(s) used for data transmission. In some examples, the TRP/BS may follow UE recommendation and may use the beam with the best reported RSRP for data transmission. In some examples, the TRP/BS change or refine the beam. The TRP may indicate the UE which beams to be used for data/control information transmission and the UE may use the corresponding proper receive beam for data reception.

In some examples, the TRP/BS may indicate the beamformed RS ID (e.g., indicating Tx beam ID(s)) which represents the beam. In some examples, the TRP/BS may indicate the spatial channel properties information to the UE to assist UE-side beamforming/reception. The beam indication may be conducted via multi-stage indication for QCL among RS ports, via joint higher layer signaling and physical layer signaling to reduce the overhead while maintaining the flexibility of beam indication. In some examples, up to a first number (e.g., 128) beams may be configured by Radio Resource Control (RRC) layer signaling. Out of the first number candidate beams, up to a second number (e.g., 8) candidate beams may be selected by MAC layer signaling. The physical layer signaling may be used to indicate the beam (out of the second number of beams) for data transmission.

In some examples, the beam maintenance process (including beam tracking and refinement) may be designed to handle beam misalignment caused by unexpected UE mobility and to support beam refinement from wide to narrow beams. The beam maintenance process may involve beam tracking or refinement per Tx/Rx beam(s) which may be supported by P2 and P3 respectively. Through probing neighboring beams, beam tracking may efficiently track and compensate the change of optimal transmission direction. In some examples, the beam refinement may be

[symbol]

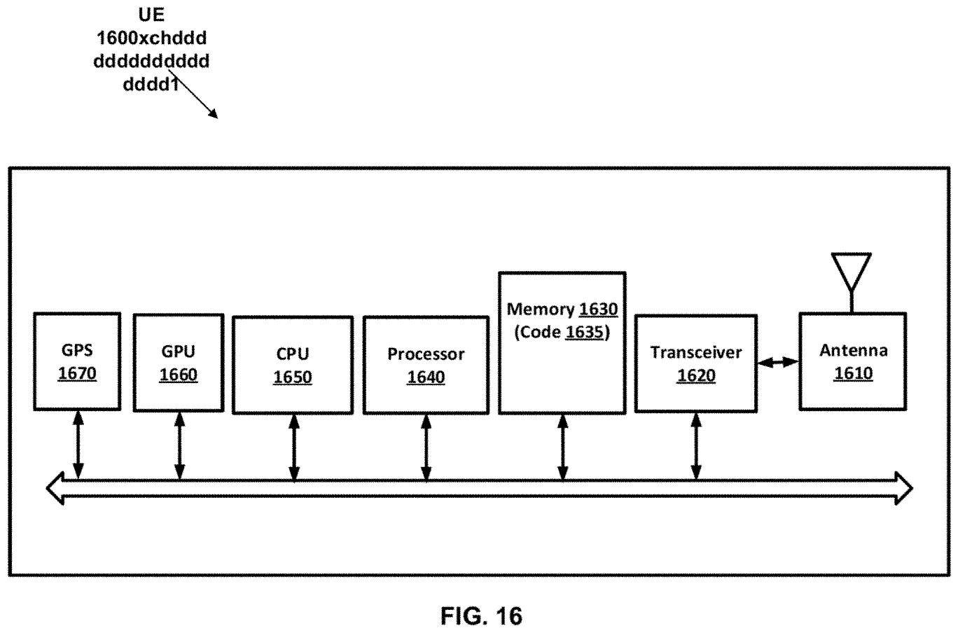

FIG. 16 shows example components of a user equipment for transmission and/or reception according to some aspects of some of various exemplary embodiments of the present disclosure. All or a subset of blocks and functions in FIG. 16 may be in the user equipment 1600 and may be performed by the user equipment (e.g., 125A-E). The Antenna 1610 may be used for transmission or reception of electromagnetic signals. The Antenna 1610 may comprise one or more antenna elements and may enable different input-output antenna configurations including Multiple-Input Multiple Output (MIMO) configuration, Multiple-input Single-Output (MISO) configuration and Single-Input Multiple-Output (SIMO) configuration. In some embodiments, the Antenna 1610 may enable a massive MIMO configuration with tens or hundreds of antenna elements. The Antenna 1610 may enable other multi-antenna techniques such as beamforming. In some examples and depending on the UE 1600 capabilities or the type of UE 1600 (e.g., a low-complexity UE), the UE 1600 may support a single antenna only.

The transceiver 1620 may communicate bi-directionally, via the Antenna 1610, wireless links as described herein. For example, the transceiver 1620 may represent a wireless transceiver at the UE and may communicate bi-directionally with the wireless transceiver at the base station or vice versa. The transceiver 1620 may include a modem to modulate the packets and provide the modulated packets to the Antennas 1610 for transmission, and to demodulate packets received from the Antennas 1910.

The memory 1630 may include RAM and ROM. The memory 1630 may store computer-readable, computer-executable code 1635 including instructions that, when executed, cause the processor to perform various functions described herein. For instance, code 1635 when executed, may perform DMRS bundling process management including channel measurements, DMRS bundling determination, etc., as described previously. In some examples, the memory 1630 may contain, among other things, a Basic Input/output System (BIOS) which may control basic hardware or software operation such as the interaction with peripheral components or devices.

The processor 1640 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1640 may be configured to operate a memory using a memory controller. In other examples, a memory controller may be integrated into the processor 1640. The processor 1640 may be configured to execute computer-readable instructions stored in a memory (e.g., the memory 1930) to cause the UE to perform various functions.

The Central Processing Unit (CPU) 1650 may perform basic arithmetic, logic, controlling, and Input/output (I/O) operations specified by the computer instructions in the Memory 1630. The user equipment 1600 may include additional peripheral components such as a graphics processing unit (GPU) 1660 and a Global Positioning System (GPS) 1670. The GPU 1660 is a specialized circuitry for rapid manipulation and altering of the Memory 1630 for accelerating the processing performance of the user equipment 1600. The GPS 1670 may be used for enabling location-based services or other services for example based on geographical position of the user equipment 1600.

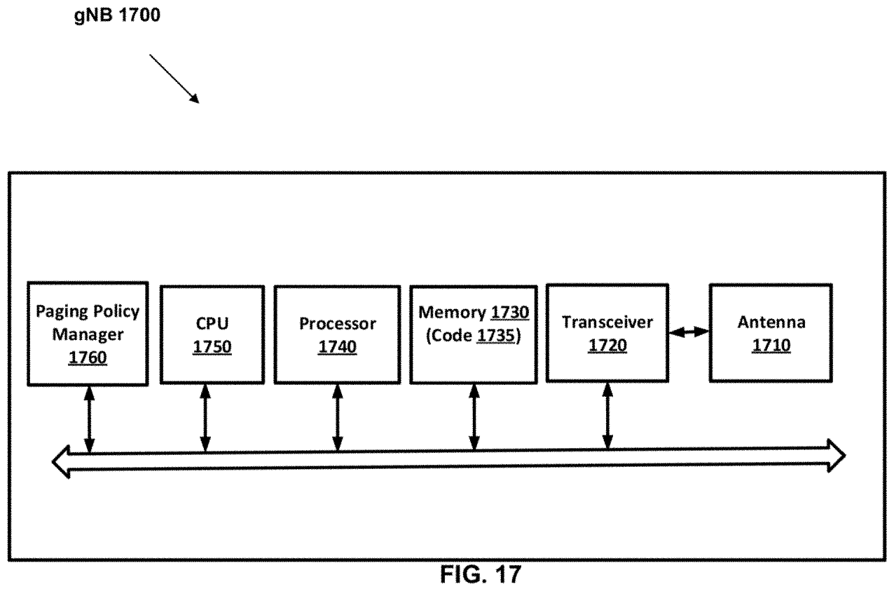

FIG. 17 shows example components of a base station 1700 for transmission and/or reception according to some aspects of some of various exemplary embodiments of the present disclosure. All or a subset of blocks and functions in FIG. 17 may be in the base station 1700 and may be performed by the BS (e.g., 115A-B, 1705). The Antenna 1710 may be used for transmission or reception of electromagnetic signals. The Antenna 1710 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 1710 may enable a massive MIMO configuration with tens or hundreds of antenna elements. The Antenna 1710 may enable other multi-antenna techniques such as beamforming. In some examples and depending on the base station 1700 capabilities or the type of base station 1700 (e.g., a low-complexity UE), the base station 1700 may support a single antenna only.

The transceiver 1720 may communicate bi-directionally, via the Antenna 1710, wireless links as described herein. For example, the transceiver 1720 may represent a wireless transceiver at the UE and may communicate bi-directionally with the wireless transceiver at the base station or vice versa. The transceiver 1720 may include a modem to modulate the packets and provide the modulated packets to the Antennas 1710 for transmission, and to demodulate packets received from the Antennas 1710.

The memory 1730 may include RAM and ROM. The memory 1730 may store computer-readable, computer-executable code 1735 including instructions that, when executed, cause the processor to perform various functions described herein. For instance, code 1635 when executed, may perform DMRS bundling process management including channel measurements, DMRS bundling determination, etc., as described previously In some examples, the memory 1730 may contain, among other things, a Basic Input/output System (BIOS) which may control basic hardware or software operation such as the interaction with peripheral components or devices.

The processor 1740 may include a hardware device with processing capability (e.g., a general purpose processor, a DSP, a CPU, a microcontroller, an ASC, an FPGA, a programmable logic device, a discrete gate or transistor logic component, a discrete hardware component, or any combination thereof). In some examples, the processor 1740 may be configured to operate a memory using a memory controller. In other examples, a memory controller may be integrated into the processor 1740. The processor 1740 may be configured to execute computer-readable instructions stored in a memory (e.g., the memory 1730) to cause the base station 1700 to perform various functions.

The Central Processing Unit (CPU) 1750 may perform basic arithmetic, logic, controlling, and Input/output (I/O) operations specified by the computer instructions in the Memory 1730.

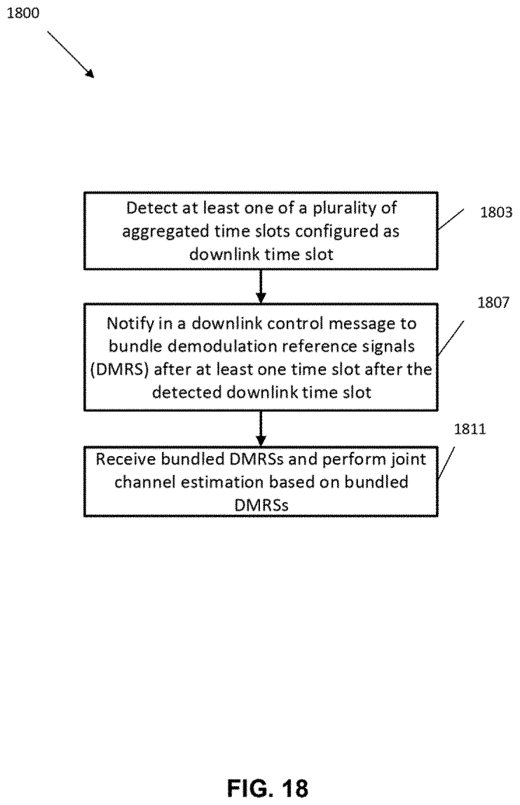

FIG. 18 is a flow diagram of a method 1800 for a BS performing DMRS bundling determination process according to some aspects of the present disclosure. The method 1800 is implemented by a BS (e.g., BS 115A-B, BS 120A-B). The steps of method 1800 can be executed by computing devices (e.g., a processor, processing circuit, and/or other components) of the UE. As illustrated, the method 1800 may include additional steps before, after, and in between the enumerated steps.

At step 1803, the BS detects at least one of the plurality of aggregated time slots configured as DL time slot. For instance, the UE may detect the first available DL time slot to measure the channel characteristic, and determine if DMRS bundling can improve the performance. The UL channel may be measured from DMRS.

At step 1807, the BS notifies the UE, the DMRS to be bundled in a DCI message after at least one time slot after at least one time slot after the detected downlink time slot. The at least one time slot is used as a time gap to allow the UE to have sufficient time for bundling DMRSs. The UE may also use the time gap to perform an LBT process, to switch to a to a new frequency channel in the PUSCH repetition with frequency hop.

At step 1811, the BS receives bundled DMRSs and performs joint channel estimation based on the bundled DMRSs across multiple PUSCHs.

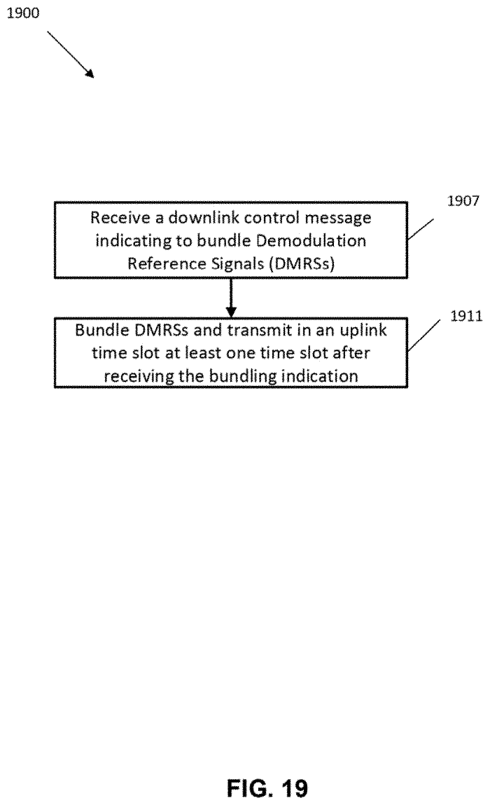

FIG. 19 is a flow diagram of a method 1900 for a UE performing DMRS bundling process according to some aspects of the present disclosure. The method 1900 is implemented by a UE (e.g., UE 125C-D). The steps of method 1900 can be executed by computing devices (e.g., a processor, processing circuit, and/or other components) of the UE. As illustrated, the method 1900 may include additional steps before, after, and in between the enumerated steps.

At step 1907, the UE receives a DCI message from a BS indicating to bundle DMRSs for multiple PUSCHs.

At step 1911, the UE bundles DMRSs in multiple PUSCHs, and transmits bundled DMRS after a time gap including at least one time symbol once it receives bundling indication from the BS. The time gap may allow the UE to measure the channel and consider DMRS bundling. The UE may also use the time gap to perform an LBT process, to switch to a to a new frequency channel in the PUSCH repetitions with frequency hop.

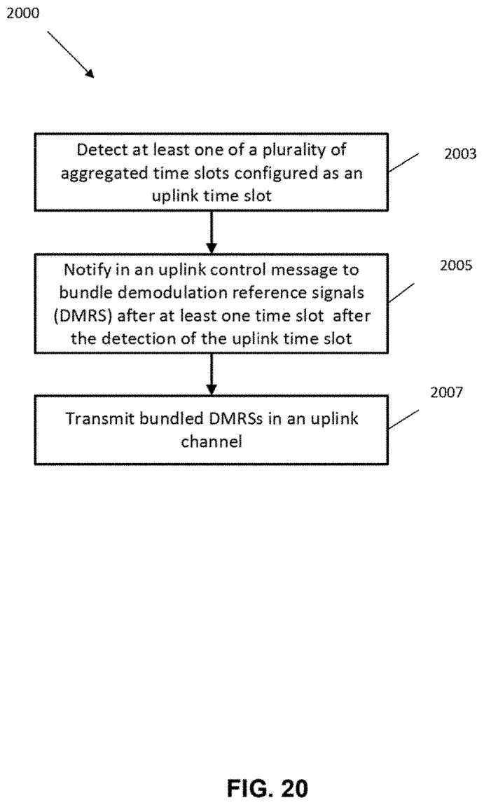

FIG. 20 is a flow diagram of a method 1800 for a UE performing DMRS bundling determination process according to some aspects of the present disclosure. The method 2000 is implemented by a BS (e.g., BS 115A-B, BS 120A-B). The steps of method 2000 can be executed by computing devices (e.g., a processor, processing circuit, and/or other components) of the UE. As illustrated, the method 2000 may include additional steps before, after, and in between the enumerated steps.

At step 2003, the UL detects at least one of the plurality of aggregated time slots configured as UL time slot. For instance, the UE may detect the first available UL time slot to measure the channel characteristic, and determine if DMRS bundling can improve the performance. In some examples, the UE may measure the DL channel, and use the channel reciprocity to estimate UL channel. In some examples, the UE may also measure UL channel quality from ACK/NACK feedback.

At step 2005, the UE notifies the BS, the DMRSs to be bundled in a UCI message after at least one time slot after at least one time slot after the detected UL time slot. The at least one time slot is used as a time gap to allow the UE to have sufficient time for bundling DMRSs. The UE may also use the time gap to perform an LBT process, to switch to a to a new frequency channel in PUSCH repetitions with frequency hop.

At step 2007, the UE transmits bundled DMRSs in UL link after the UE bundles DMRSs in multiple PUSCHs, and transmits bundled DMRS after a time gap including at least one time symbol after the bundling indication in UCI.

FIG. 19 is a flow diagram of a method 1900 for a UE performing DMRS bundling process according to some aspects of the present disclosure. The method 1900 is implemented by a UE (e.g., UE 125C-D). The steps of method 1900 can be executed by computing devices (e.g., a processor, processing circuit, and/or other components) of the UE. As illustrated, the method 1900 may include additional steps before, after, and in between the enumerated steps.

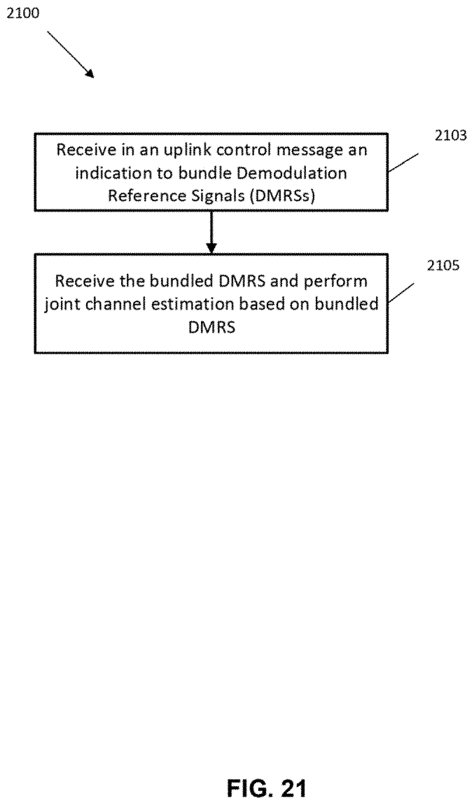

FIG. 21 is a flow diagram of a method 2100 for a BS performing DMRS bundling process according to some aspects of the present disclosure. The method 2100 is implemented by a UE (e.g., UE 125C-D). The steps of method 2100 can be executed by computing devices (e.g., a processor, processing circuit, and/or other components) of the UE. As illustrated, the method 2100 may include additional steps before, after, and in between the enumerated steps.

At step 2103, the BS receives an uplink bundling indication in an UCI message from the UE.

At step 2105, the BS receives bundled DMRSs in UL link, and performs joint channel estimation on multiple PUSCH. The BS receives the indication message after a time gap including at least one time symbol after receiving the DMRS bundling indication from the UE. In some examples, in PUSCH repetition with frequency hopping, the UE may use the time gap to perform an LBT for switching to a new frequency channel.

The exemplary blocks and modules described in this disclosure with respect to the various example embodiments may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Examples of the general-purpose processor include but are not limited to a microprocessor, any conventional processor, a controller, a microcontroller, or a state machine. In some examples, a processor may be implemented using a combination of devices (e.g., a combination of a DSP and a microprocessor, multiple microprocessors, one or more microprocessors in conjunction with a DSP core, or any other such configuration).

The functions described in this disclosure may be implemented in hardware, software executed by a processor, firmware, or any combination thereof. Instructions or code may be stored or transmitted on a computer-readable medium for implementation of the functions. Other examples for implementation of the functions disclosed herein are also within the scope of this disclosure. Implementation of the functions may be via physically co-located or distributed elements (e.g., at various positions), including being distributed such that portions of functions are implemented at different physical locations.

Computer-readable media includes but is not limited to non-transitory computer storage media. A non-transitory storage medium may be accessed by a general purpose or special purpose computer. Examples of non-transitory storage media include, but are not limited to, random access memory (RAM), read-only memory (ROM), electrically erasable programmable ROM (EEPROM), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable media.

As used in this disclosure, use of the term “or” in a list of items indicates an inclusive list. The list of items may be prefaced by a phrase such as “at least one of’ or “one or more of’. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

1. A method of data transmission, comprising the steps of:
detecting, by a base station, at least one of a plurality of aggregated time slots configured as a downlink (DL) time slot;
determining whether to bundle plurality of demodulation reference signals (DMRSs);
transmitting, to a user equipment (UE), a downlink control message (DCI) in the DL time slot;
waiting, by the base station, for a time duration corresponding to a length of at least one symbol as a first indication gap;
receiving, from the UE, the plurality of bundled DMRSs; and
performing channel estimation based on the bundled DMRSs.

2. The method of claim 1, wherein the step of determining comprises
measuring a wireless channel between the base station (BS) and the user equipment (UE), and based on the measurements, determining whether to bundle demodulation reference signals (DMRSs) or not.

3. The method of claim 1, wherein the plurality of bundled demodulation reference signals (DMRSs) are in at least one physical uplink shared channel (PUSCH) repetition.

4. The method of claim 3, further comprising:
receiving a first set of bundled demodulation reference signals (DMRSs) in a first physical uplink shared channel (PUSCH) repetition in a first frequency band;
waiting, by the base station, for a second time duration corresponding to a length of at least one symbol as a second indication gap;
hopping, by the user equipment (UE), to a second frequency band; and
receiving a second set of bundled DMRSs in a second PUSCH repetition in a second frequency band.

5. The method of claim 4, wherein the second indication gap is used by the user equipment (UE) to perform a Listen-Before-Talk (LBT) process.

6. The method of claim 4, wherein the second indication gap is used by the user equipment (UE) to perform a Listen-Before-Talk (LBT) process.

7. The method of claim 1, wherein the plurality of bundled DMRSs are received in one or more aggregated time slots.

8. The method of claim 7, wherein the channel estimation is performed using the bundled DMRSs in the one or more aggregated time slots.

9. The method of claim 1, wherein the detecting comprises identifying a first available DL slot.

10. The method of claim 3, wherein the physical uplink shared channel (PUSCH) repetition is a PUSCH type A repetition.

11. The method of claim 3, wherein the physical uplink shared channel (PUSCH) repetition is a PUSCH type B repetition.

12. The method of claim 3, wherein the at least one physical uplink shared channel (PUSCH) repetitions are PUSCH type A repetitions.

13. The method of claim 3, wherein the at least one physical uplink shared channel (PUSCH) repetitions are PUSCH type B repetitions.

14. A base station (BS), comprising:
a processor configured to detect at least one of a plurality of aggregated time slots configured as a downlink (DL) time slot; and
a transceiver in communication with the processor and configured to:
transmit a first set of bundled DMRSs in a first physical uplink shared channel (PUSCH) repetition in a first frequency band; and
receive a second set of bundled demodulation reference signals (DMRSs) in a second PUSCH repetition in a second frequency band.

15. A user equipment (UE), comprising:
a processor configured to detect at least one of a plurality of aggregated time slots configured as downlink (UL); and
a transceiver in communication with the processor and configured to:
transmit a first set of bundled demodulation reference signals (DMRSs) in a first physical uplink shared channel (PUSCH) repetition in a first frequency band;
transmit a second set of bundled DMRSs in a second PUSCH repetition in a second frequency band; and
wait for a time duration corresponding to a length of at least one symbol as a first indication gap;
wherein the processor performs channel estimation based on the bundled DMRSs.
